(19) United States
(12) Patent Application Publication
(10) Pub. No.: US 2018/0258117 A1
(43) Pub. Date: Sep. 13, 2018

(54) 2D MATERIALS

(71) Applicant: The University of Manchester, Manchester (GB)

(72) Inventors: Paul O'Brien, Manchester (GB); Nicky Savjani, Manchester (GB); John (Jack) R. Brent, Manchester (GB)

(21) Appl. No.: 15/760,554

(22) PCT Filed: Sep. 15, 2016
(86) PCT No.: PCT/EP2016/071868

§ 371 Date: Mar. 15, 2018

(30) Foreign Application Priority Data
Sep. 16, 2015 (GB) 1516394.2
Apr. 22, 2016 (GB) 1607007.0

(51) Int. Cl. C07F 11/00; C07F 7/00; C01G 39/06; C01B 19/00

(52) U.S. Cl. CPC C07F 11/005; C07F 7/006; C01G 39/06; C01B 19/007; C01P 2002/52; C01P 2002/72; C01P 2006/80; C01P 2002/85; C01P 2002/88; C01P 2004/04; C01P 2004/24; C01P 2004/64; C01P 2006/42; C01P 2002/82

(57) ABSTRACT

The synthesis of 2D metal chalcogenide nanosheets and metal-ion or metalloid-ion doped 2D metal chalcogenide nanosheets by adding a metal complex to a hot dispersing medium. The mean lateral dimension of the nanosheets may be controlled by appropriate temperature selection.

This application claims priority from GB 1516394.2 filed 16 Sep. 2015 and from GB 1607007.0 filed 22 Apr. 2016, the contents of which are herein incorporated by reference in their entirety for all purposes.

### FIELD OF THE INVENTION

The present invention relates to a process for synthesizing two-dimensional (2D) materials, including binary 2D materials such as MoS₂ or WS₂, and related alloys such as those of general formula MoₓW₁₋ₓS_{2-y}Se_{y}, in addition to other related analogues. The synthesis of metal-ion or metalloid-ion doped 2D metal chalcogenide nanosheets is also disclosed.

### BACKGROUND

Since the discovery of graphene in 2004, two-dimensional materials of atomic thickness have captivated the imagination of the research community. Inspired by the unique properties and potential applications of graphene, a family of 2D nanosheets produced from transition metal chalcogenides (2D-TMCs) have also been extensively investigated. These materials have a similar structure to graphene.

2D-TMCs have a rich diversity of electronic, optical, thermal, mechanical and reactivity profiles, and have been recognized as suitable systems for studying the transition from the atomic-thickness to macrocrystalline level. Interest in research into new synthetic routes for two-dimensional materials that exhibit either metallic or semiconducting properties is now enhanced as devices based on such materials have been fabricated. A number of synthetic methods have been reported for the preparation of a wide range of semiconducting and metallic nanosheets.

Known processes for preparing 2D materials, such as MoS₂, have included the exfoliation of bulk lamellar crystals, gas phase syntheses (which include chemical vapour deposition and physical vapour transport) and the liquid-phase reaction of molecular species at high temperatures in organic solvents.

In more detail, Altavilla et al reported on the liquid-phase preparation of MS₂ monolayers (where M═Mo or W) capped with a coordinating solvent by the thermolysis of an organometallic reagent in a hot coordinating solvent.³ In particular, the Altavilla process involves heating a solution of [NH₄]₂[MS₄] in oleylamine (OM) to 360° C. for 30 minutes.

An alternate approach to the Altavilla process was proposed by the Li and Liu groups.^{[4a]} In the Li/Liu process freestanding WS₂ monolayers capped with oleylamine are prepared by the thermolysis of two organometallic reagents by injection into a hot coordinating solvent. In particular, the Li/Liu process involves injecting a solution of sulfur in oleylamine into a hot solution of oleylamine containing WCl6 (W-OM and OM) at 300° C. for 1 hour. Lui et al. have also demonstrated that this method can be used to produced transition metal doped WS₂ by dissolving transition metal chlorides in the reaction medium.^{[4b]}

There are however problems associated with the prior art processes for preparing freestanding 2D materials from the liquid phase. For example, both the Altavilla and Li/Liu produce the MS₂ materials having a broad distribution of size (for example, 5-20 nm variation in lateral dimension within a single reaction from the Li/Liu process). In addition, both the Altavilla and Li/Liu processes use air sensitive reagents which complicate its use for larger scale syntheses. In addition, no processes are known for the synthesis of small two-dimensional metal selenides from a liquid phase.

There is a need in the art for improved processes for the production of two-dimensional metal sulphides and for processes for the production of two-dimensional metal selenides.

### SUMMARY

The present invention provides methods for the synthesis of 2D metal chalcogenide nanosheets, the method comprising adding a metal complex to a dispersing medium, wherein the complex comprises a metal ion and a ligand comprising at least two atoms selected from oxygen, sulfur, selenium and tellurium.

The 2D metal chalcogenide nanosheets may optionally contain dopant metal or metalloid ions. In this context, dopant ion refers to ion introduced into the nanosheets themselves to produce an alloyed material. In other words, the dopant ions “replace” metal centres in the 2D nanosheets (that is, as a doping agent). Doping is achieved by performing the method in the presence a salt of said metal or metalloid ion.

Doping permits band gap tuning of the materials, providing materials with useful extrinsic properties.

As described herein, the extent of doping can be controlled by the relative ratios of complex and dopant ion salt. Naturally, the type of dopant may be chosen by using an appropriate metal or metalloid salt. As a result, the properties of the resultant doped-nanosheet may be adjusted. For example, the degree of magnetisation may be adjusted.

Accordingly, the invention further provides methods for the synthesis of metal-ion or metalloid-ion doped 2D metal chalcogenide nanosheets, the method comprising adding a metal complex to a dispersing medium, wherein the reaction is performed in the presence of a salt of said metal or metalloid ion, and wherein the complex comprises a metal ion and a ligand comprising at least two atoms selected from oxygen, sulfur, selenium and tellurium.

In some cases, the reaction is performed in the presence of a metal salt and the product is metal-ion doped 2D metal chalcogenide nanosheets. Suitably, the metal is a d- or p-block metal. Preferred d-block metals may include manganese, iron, cobalt, nickel, copper, and zinc. Preferred p-block metals may include gallium, indium, tin, lead, and bismuth.

It will be appreciated that the metal dopant may be selected to tune the properties of the resulting doped nanosheets to suit the intended use.

In some cases, the reaction is performed in the presence of a metalloid salt and the product is metalloid-ion doped 2D metal chalcogenide nanosheets. Preferred metalloids may include germanium, arsenic, and antimony. Once again, it will be appreciated that the metal dopant may be selected to tune the properties of the resulting doped nanosheets to suit the intended use.

The salt counter ion may be any suitable anion. Suitable counterions include halides (F⁻, Cl⁻ Br⁻, I⁻, sulfates and nitrates. Halides may be preferred. A particularly preferred halide, as demonstrated in the examples, is chloride. The inventors have observed that chloride salts have good solubility in oleylamine, which is a preferred dispersing medium.

It will be understood that the metal chalcogenide may be binary, ternary or even quaternary in structure.

In some cases, the metal ion in the complex is in the +4 oxidation state (in other words, the metal ion is an M^{IV} ion). However, it will be appreciated that the metal ion in the complex may be in an oxidation state from 0 to +6. Oxidation or reduction to the most thermodynamically stable oxidation state, usually but not always the +4 oxidation states, occurs during the reaction.

The complex may comprise more than one metal ion. For example, the complex may have 1 to 4 metal ions, for example, 1, 2, or 4 metal ions. The or each metal ion may be selected from a transition metal ion such as a titanium ion, a zirconium ion, a hafnium ion, a vanadium ion, a niobium ion, a tantalum ion, a molybdenum ion, a tungsten ion, a technetium ion, a rhenium ion, a palladium ion, and a platinum ion. Additionally or alternatively, the metal ion may be a non-transition metal ion (a so-called main group metal ion) such as a gallium ion, an indium ion, a germanium ion, a tin ion, and a bismuth ion.

Some preferred transition metals include molybdenum and tungsten. Some preferred main group metals include gallium, indium, and tin.

The number of metal ions, and indeed the complex type, may be determined by the nature of the metal.

Similarly, the structure of the 2D material may be determined by the nature of the metal. For example, transition metal-based 2D materials are typically MX₂ in type. Some exceptions are known; for example, group V metals may form MX₃ complexes, while rhenium (group VII) is known to form Re₂S_{7.} More variety may be observed for main group ions. Without limitation, gallium, germanium and tin may produce MX-type 2D materials, tin may produce MX₂-type materials, indium and bismuth may produce M₂X₃-type materials.

In some cases, the or each metal ion is selected from molybdenum or tungsten. In some cases, at least one metal ion is a molybdenum ion.

Where more than one ion is present in a complex, the ions may be the same or different. In some embodiments, all of the metal ions in a complex are the same.

In some cases, there are exactly two metals ions in the complex. In other words, the complex is a bimetallic complex.

In some cases, the, any, or each ligand is a chalcogenocarbamate or chalcogenocarbonate ion. The chalcogenocarbamate or chalcogenocarbonate may, in some cases, be a dithiol-carbamate, a dithiol-carbonate (xanthate) or a ditelluro-carbonate; or a diseleno-carbamate, a diseleno-carbonate or a ditelluro-carbamate.

The chalcogenocarbamate or chalcogenocarbonate ion may be of general formula (I):

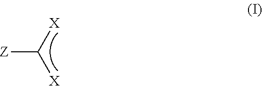

wherein

each X is independently selected from O, S, Se, and Te;

Z is OR¹ or NR²R³;

R¹, R², and R³ are independently selected from optionally substituted alkyl, alkyenyl, cycloalkyl, cyclocalkyl-C₁₋₆alkyl, cycloalkenyl, cycloalkenyl-C₁₋₆alkyl, heterocyclyl, heterocyclyl-C₁₋₆alkyl, aryl, aryl-C₁₋₆alkyl, and heteroaryl-C₁₋₆alkyl.

The alkyl or alkenyl may be C₁₋₃₀, for example C₁₋₂₅, for example C₁₋₂₀, for example C₁₋₁₈, for example C₁₋₁₅, for example C₁₋₁₀, preferably C₁₋₆, for example ethyl or methyl. Alkyl and alkenyl may, valance permitting, be branched or straight chain.

The cycloalkyl or cycloalkenyl may be C₃₋₂₀, for example, C₃₋₁₂, for example C₆₋₁₀. Cycloalkyl and cycloalkenyl groups may, valance permitting, be monocyclic or polycyclic ring systems, for example, fused, bridged or even spiro.

Heterocyclyl refers to a cyclic 5 to 10 membered alicyclic group comprising at least one atom selected from nitrogen, sulfur and oxygen. Examples having a single nitrogen atom may include piperidino, pyrrolidino, and rings having a further heteroatom, for example, morpholino. Where a further nitrogen atom is present, for example, in rings having two nitrogen atoms, such as piperazino, preferably the second nitrogen atom is substituted, for example, with a C₁₋₄ alkyl. This improves ease of ligand synthesis (as the second nitrogen does not compete during chalcogenocarbamate formation).

Aryl refers to aromatic C₆₋₂₀ carbocycles including phenyl, naphthyl, and anthracenyl.

Heteroaryl refers to aromatic 5 to 10 membered cyclic structures comprising at least one atom selected from nitrogen, sulfur and oxygen. An example is pyridyl.

A preferred aryl-C₁₋₆alkyl is benzyl.

Groups may be optionally substituted with 1, 2, 3, 4, 5 or more substituents, valance permitting. In some cases, groups are unsubstituted or bear only one substituent.

Preferably, groups are unsubstituted. Substituents may include halogens (F, Cl, Br, I), C₁₋₆alkyl or alkenyl (where the group itself is not an alkyl or alkenyl), hydroxyl and C₁₋₄alkoxy.

Preferably, each X is independently selected from O, S, and Se, for example from S and Se. Preferably, the chalcogenocarbamate or chalcogenocarbonate is a dithiol-carbamate or a dithiol-carbonate (xanthate) or a diseleno-carbamate or diseleno-carbonate.

In some cases, the metal complex may comprise a moiety of formula (II)

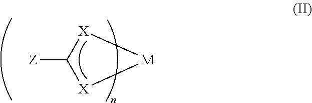

where M is a metal ion; n may be 1, 2, or 3, and X and Z are as described herein.

The metal ion may be in the +2, +3, +4, +5, +6 or even higher oxidation states, depending on whether the metal complex is of formula MX, M2X3, MX2 or MX3 etc.

Each X in a complex may be the same or different. In some cases, each X is sulfur. In some cases, each X is selenium.

In some cases, Z is OR¹. In some preferred embodiments, R¹ is C₁₋₆ alkyl or phenyl, more preferably C₁₋₆ alkyl. For example, R¹ may be methyl, ethyl, n-propyl, i-propyl, n-butyl, i-butyl, s-butyl, t-butyl, pentyl or hexyl. In some embodiments, R¹ is ethyl; that is, Z is OEt.

In some cases, Z is NR²R³. In some preferred embodiments, R² is C₁₋₆ alkyl or phenyl, more preferably C₁₋₆ alkyl. For example, R² may be methyl, ethyl, n-propyl, i-propyl, n-butyl, i-butyl, s-butyl, t-butyl, pentyl or hexyl. In some embodiments, R² is ethyl. In some preferred embodiments, R³ is C₁₋₆ alkyl or phenyl, more preferably C₁₋₆ alkyl. For example, R³ may be methyl, ethyl, n-propyl, i-propyl, n-butyl, i-butyl, s-butyl, t-butyl, pentyl or hexyl. In some embodiments, R³ is ethyl. In some embodiments, both R²and R³ are ethyl; that is, Z is NEt₂.

The complex may have only one metal centre. It may be coordinated to 2, 3, 4, or 5 bidentate ligands, depending on the metal centre used. In these cases, suitably the metal complex is a complex of formula (III):

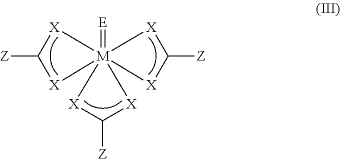

wherein E is O, S, Se, or Te, preferably O, S, or Se. In this case, the metal is a +5 centre, which will reduce to a +4 centre during the reaction.

In some cases, the complex has exactly two metal centres. The complex may be a complex of formula (IV):

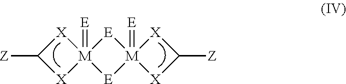

where all atoms and groups are as described herein (including bridging E, which may be as described above).

In some cases, the complex has exactly two metal centres. The complex may be a complex of formula (V):

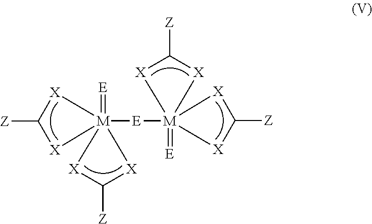

where all atoms and groups are as described herein.

For each ligand, the or each bridging E may be oxygen, sulfur, selenium, or tellurium, preferably sulfur or oxygen.

A four metal complex can also be envisaged:

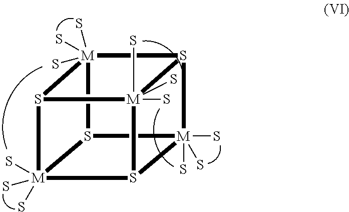

For simplicity, the chalcogenocarbamate or chalcogenocarbonate ions of formula (I) have been simplified to S∩S.

Suitably, the complex is a complex that undergoes thermal decomposition (thermolysis) at a temperature of or below 400° C., for example, of or below 350° C., such as of or below 300° C., preferably of or below 275° C., for example, of or below 250° C. In some cases, the complex is a complex that undergoes thermal decomposition at 200° C. (in other words, the minimum decomposition temperature is 200° C. or lower).

Preferably, the complex is a complex of formula (IV).

In some embodiments, the complex is a complex selected from [Mo₂O₄(S₂CNEt₂)₂], [Mo₂O₂S₂(S₂CNEt₂)₂], [Mo₂S₄(S₂CNEt₂)₂], [Mo₂O₂S₂(S₂COEt)₂] and [Mo₂S₄(S₂COEt)₂]. A preferred complex is [Mo₂O₂S₂(S₂COEt)₂].

Of course, the present invention encompasses methods in which the complex comprises a ligand that is not a chalcogenocarbamate or chalcogenocarbonate ion. Without limitation, the, any, or each ligand may be an ion of formula (VII) or (VIII):

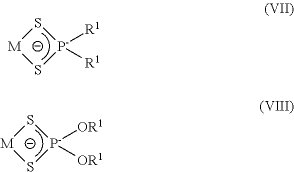

wherein R¹ may be as defined above.

Additionally or alternatively, the, any, or each ligand may be an ion of formula (IX) or (X):

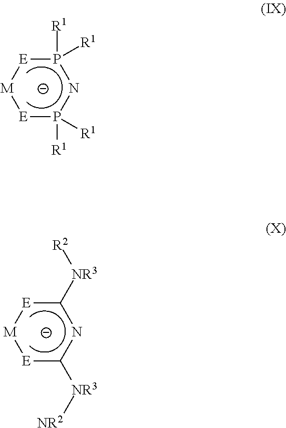

where E, R¹, R², and R³ are as previously defined.

As used herein, dispersing medium refers a suitable coordinating solvent into which the metal complex is added, and in which the synthesis of the nanosheets occurs. While the complex itself may be soluble in the dispersing medium, once the nanosheets begin to form, they form as a dispersion in the dispersing medium.

The dispersing medium includes a coordinating group, for example an amino or hydroxyl group, a carboxyl acid or other acid group (for example phosphonic acid), a phosphine group or a phosphine oxide group. It will be appreciated that it is important that the dispersing medium's boiling point is sufficiently high to permit the high temperatures of the reaction. Suitably, therefore, the dispersing medium is a monoamine, monoalcohol, monocarboxylic acid or a monophosphonic acid, having a boiling point >250° C., preferably >300° C., for example >350° C. Other suitable dispersing media include tri-substituted phosphines and tri-substituted phosphine oxides.

Suitably, the dispersing medium comprises at least one fatty chain R^{A}, for example a C₈₋₃₀ alkyl or alkenyl chain or a C₈₋₃₀ alkylaryl or arylalkyl group.

In some cases, the R^{A} is an alkyl or alkenyl that is not branched, in other words, each carbon atom save the terminal atom is bound only to two other carbon atoms.

In some cases, R^{A} is oleyl (i.e. octadec-9-en-1-yl). Accordingly, the amine may be oleylamine. In some cases, R^{A} is octadecyl. Accordingly, the amine may be ocadecylamine.

In some cases, R^{A} is an alkylaryl or arylalkyl group. For example, R^{A} may be a nonylphenyl (for example, a 4-(2,4-dimethylheptan-3-yl)phenyl).

In some cases, the dispersing medium comprises a fatty chain and an amino group. In other words, in some cases, the dispersing medium is an amine having a fatty chain.

Suitably, the amine is a primary amine. In other words, the amine is an amine of formula

H₂NR^{A}, wherein R^{A} is an alkyl group, alkenyl group, alkylaryl group or arylalkyl group. Suitably, R^{A} comprises 8 to 30 carbon atoms, for example, 10 to 30 carbon atoms, 10 to 25 carbon atoms, 15 to 25 carbon atoms, 15 to 20 carbon atoms, for example, it may be C₁₅, C₁₆, C₁₇, C₁₈, C₁₉, or C₁₀.

In some cases, the dispersing medium comprises a hydroxyl group. Suitably, the hydroxyl group is a primary hydroxyl group. In other words, the dispersing medium is an alcohol of formula R^{A}OH, where R^{A} is as described above. For example, in some cases the dispersing medium is nonylphenol.

In some cases, the dispersing medium comprises a phosphonic acid group. The dispersing medium may be a compound of formula R^{A}PO(OH)₂, where R^{A} is as described above. For example, in some cases the dispersing medium is n-octylphosphonic acid.

In some cases, the dispersing medium comprises a phosphine group. The dispersing medium may be a tri-substituted phosphine (R^{A}₃P) such as, for example, tri-n-octyl phosphine (TOP).

In some cases, the dispersing medium comprises a phosphine oxide group. The dispersing medium may be a tri-substituted phosphine oxides such as, for example, tri-n-octyl phosphine oxide (TOPO).

Suitably, the complex is added as a solution. The solution solvent is preferably the same as the dispersing medium into which the solution is added, but any suitable solvent may be used.

The reaction proceeds via decomposition of the metal complex which provides both metal and chalcogenide ions. A postulated mechanism for certain molybdenum-/sulfur-containing complexes via a Chugaev elimination is described herein. Suitably, the dispersing medium is heated when the solution is added. In other words, suitably the dispersing medium is at elevated temperature (above room temperature) at the time of adding the metal complex.

The high temperatures provide sufficient energy for decomposition to begin. For example, at addition of the complex (e.g. at a solution) the dispersing medium may be at a temperature of 200° C. or more, preferably from 250-325° C.

The invention provides nanosheets of a 2D metal chalcogenide material. The 2D material may be selected from any one of titanium oxide, titanium sulfide, titanium selenide, titanium telluride, zinc oxide, cobalt oxide, zirconium sulfide, zirconium selenide, hafnium sulfide, hafnium selenide, vanadium sulfide, vanadium selenide, niobium sulfide, niobium selenide, bismuth selenide, bismuth telluride, tantalum sulfide, tantalum selenide, molybdenum sulfide, molybdenum selenide, tin sulfide (tin(II) and tin(IV)), tungsten sulfide, tungsten selenide, technetium sulfide, technetium selenide, rhenium sulfide and rhenium selenide, including ternary and quaternary combinations thereof. These materials are known to exist in lamellar forms (as bulk 2D materials).

For example, the 2D material may be selected from titanium sulfide, titanium selenide, zirconium sulfide, zirconium selenide, hafnium sulfide, hafnium selenide, vanadium sulfide, vanadium selenide, niobium sulfide, niobium selenide, tantalum sulfide, tantalum selenide, molybdenum sulfide, molybdenum selenide, tungsten sulfide, tungsten selenide, technetium sulfide, technetium selenide, rhenium sulfide and rhenium selenide, including ternary and quaternary combinations thereof.

The following provides representative examples of methods that may be used to obtain ternary systems:
using a solution containing both (Mo(S₂CNEt₂)₄ and W(S₂CNEt₂)₄ (in controlled ratios) to make ternary (MoₓW₁₋ₓ)S₂.
using a solution containing both Mo(S₂CNEt₂)₄ and Mo(Se₂CNEt₂)₄ to make Mo(SₓSe₁₋ₓ)₂.
using complexes in which X groups are mixed, for example, using thioselenocarbamates (or analogues), which may be coordinated to any metals to make M(SₓSe₁₋ₓ)2:

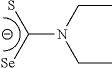

It will be appreciated that combinations of the above can be used to make quaternary systems.

In some cases, it is a binary TMC, for example selected from zinc oxide (ZnO), titanium dioxide (TiO2), titanium telluride (TiTe₂), cobalt oxide (Co₃O₄), niobium selenide (NbSe₂), molybdenum sulfide (MoS₂), molybdenum selenide (MoSe₂), tungsten sulfide (WS₂), and tungsten selenide (WSe₂).

In some cases, it is a binary compound comprising a metal which is not a transition metal, for example selected from tin(II) sulfide (SnS), tin(IV) sulphide (SnS₂), bismuth selenide (Bi₂Se₃) and bismuth telluride (Bi₂Te₃).

In some cases, it is a ternary compound. For example, it may be Mo(SₓSe₁₋ₓ)₂or (MoₓW₁₋ₓ)S₂ which is a mixture alloy of MoS₂/A₂.

In some cases, it is a quaternary compound such as (MoₓW₁₋ₓ)(SₓSe₁₋ₓ)₂.

The following representative reaction scheme is provided for illustration:

It will be understood that the sheet represents the 2D material.

The dispersing medium passivates the surface of the 2D nanosheets. In other words, the isolated flakes have dispersing medium coordinated to them. In some embodiments, the isolated flakes have a 2D material: dispersing medium ratio of 1:≤1, for example 1:≤0.5, for example between 1:0.5 and 1:0.2, such as between 1:0.35 and 1:0.25.

As described herein, a metal or metalloid salt such as a transition metal chloride may be included in the reaction mixture to produce a doped nanosheet product. For simplicity, this is described herein using the notation M-doped nanosheet, while “TM-” denotes transition metal ion doped. For example, transition metal ion doped MoS₂@olelamine may be termed (TM)-doped MoS₂@olelamine.

Suitable transition metal dopants include manganese, iron, cobalt, nickel, copper, and zinc. Suitably, the dopant is provided in a +2 oxidation state (in other words, the transition metal salt may be a transition metal chloride of formula (TM)Cl₂). Accordingly, in some cases the salt is selected from MnCl₂, CoCl₂, NiCl₂, CuCl₂, and ZnCl₂. However, other oxidation states may also be used. Without wishing to be bound by any particular theory, the inventors believe that during the reaction the conditions permit redox reactions. Accordingly, other oxidation states such as +3 oxidation states may be used. For example, to dope with iron-ions, FeCl₂ or FeCl₃ may be used. Similarly, +1 oxidation states may be used. For example, to dope with copper, CuCl or CuCl₂ may be used.

In some case, the amount of dopant used is in a ratio of 1:3 to 1:1 dopant atom:metal centres in the complex. For example, the amount of dopant used may be 1:2 dopant atom:metal centres in the complex. In other words, if the complex contains two metal centres (for example, Mo₂O₂S₂(dtc)₂ contains two Mo centres) then the molar ratio is 1:1. This equates to one mole of dopant to two moles of molybdenum.

In some cases, the amount of (TM)Cl₂ used is about 0.75 mmol w.r.t metal ions.

In some cases, the level of doping is 1-20 at % of the total number metal/metalloid centres of the nanosheet, more preferably 3-20 at %, more preferably 5-15 at %, more preferably 10-15 at %, most preferably about 12 at %.

The inventors have observed that the level of doping can be controlled based on precursor loadings. In some cases, the extent of doping is 2-4 at %. In some cases, the extent of doping is 5-7 at %. In some cases, the extent of doping is 8-10 at %. In some cases, the extent of doping is 11-13 at %. The inventors have also produced nanosheets having a higher level of doping (up to about 19 at %).

Importantly, the inventors have observed that the process for the production of 2D materials produces mono-layer material. Indeed, the inventors believe that the process (at least for certain types of material, for example, molybdenum and rhenium-based dichalogenides) may produce exclusively monolayer material. Accordingly, in some cases the process produces >90% monolayer material, preferably >95%, preferably >98%, preferably >99%, preferably >99.5%. In some embodiments, the material produced is substantially free of multilayer (i.e. two layer and higher) material. Interestingly, the inventors have observed that copper-doping may result in bilayer material. Accordingly, in some embodiments the nanosheets are Cu-doped nanosheets and the process produces >90% bilayer material, preferably >95%, preferably >98%, preferably >99%, preferably >99.5%.

Importantly, the inventors have found that the process of the invention produces 2D nanosheets having a small distribution in lateral size. This is advantageous as it produces material of excellent uniformity, which increases the usefulness of the material. As research into 2D materials advances, a concern is the exact nature of the material provided. In some embodiments, nanosheets have a mean lateral dimension of from 4 to 15 nm with a size distribution no more than ±20% of the mean lateral dimension, preferably no more than ±15%. In some embodiments, nanosheets have a mean lateral dimension of from 4 to 10 nm with a size distribution no more than ±20% of the mean lateral dimension, preferably no more than ±15 %.

In the case of M-doped nanosheets, the mean lateral size distribution may be slightly more.

For example, in some embodiments, the nanosheets have a mean lateral dimension with a size distribution no more than ±25% of the mean lateral dimension, preferably no more than ±20 %.

In some cases, the nanosheets produced have a mean lateral dimension of about 5 nm, with a size distribution no more than ±20% of the mean lateral dimension, preferably no more than ±15 %.

In some cases, the nanosheets produced have a mean lateral dimension of about 7 nm, with a size distribution no more than ±20% of the mean lateral dimension, preferably no more than ±15 %.

In some cases, the nanosheets produced have a mean lateral dimension of about 9 nm, with a size distribution no more than ±20% of the mean lateral dimension, preferably no more than ±15 %.

In some cases, the nanosheets produced have a mean lateral dimension of about 11 nm, with a size distribution no more than ±20% of the mean lateral dimension, preferably no more than ±15 %.

Importantly, the inventors have found that the lateral size of the 2D nanosheets produced can be controlled through selection of temperature. In some embodiments, the temperature of the dispersing medium (for example, oleylamine) during addition is 200-325° C., for example 225-300° C., for example 250-300° C. In some cases, certain temperatures may be used to control the size of the nanosheets obtained. In some cases, the temperature is 200-225° C. In some cases, the temperature is 225-250° C. In some cases, the temperature is 250-275° C. In some cases, the temperature is 275-300° C. In some cases, the temperature is 300-325° C. In the case of metal or metalloid ion doped materials, the temperature may preferably be around 300° C.

Very short reaction times can be used. The reaction time is defined as the time between addition of the metal complex solution and quenching of the reaction using an alcohol such as methanol or other organic solvent, for example acetone. Suitably, polar solvent is used, for example a polar protic solvent.

For example, the reaction time may be less than 30 minutes, less than 25 minutes, less than 20 minutes, less than 15 minutes. Very short reaction times of less than 10 minutes may be used, and indeed may be preferred at temperatures of 300° C. and over as in these cases, the combination of high temperature and prolonged reaction may lead to increased surface passivation and greasy materials.

In other words, in some cases a polar solvent is added less than 30 minutes, less than 25 minutes, less than 20 minutes, or less than 15 minutes after addition of the complex to the dispersing medium.

The present invention is therefore based on the finding that 2D materials can be prepared by the hot injection process using as a reactant a metal complex which provides at least two of the ions of the material (a metal and a chalcogenide). The process of the present invention above allows for the first time the control the lateral sizes of capped-MS2 produced by the hot-injection method to nanosheets (from 5 to 15 nm) with a size distribution no more than ±15% of the mean lateral dimension. The process of the present invention is therefore different to the Altavilla process and the Li/Liu process currently used.

In addition, the present invention is further advantageous over the prior art processes as it does not rely on the use of air-sensitive chemicals such as WCl₆ or [NH₄]₂[MS₄] to produce metal sulfides and selenide two-dimensional materials. The present invention is further advantageous as it provides a low-cost route to prepare materials that are potentially suited as components in electronic devices, photonic devices, memory devices, energy transfer and storage devices (i.e. batteries, supercapacitors), catalysts for small molecule production and small molecule sensing devices.

The method may further comprise isolating the nanosheets, for example by precipitation, followed by centrifugation or filtration. Precipitation may be effected by the addition of a solvent to alter the polarity of the dispersion and cause precipitation/flocculation of the dispersed particles. Suitably, the solvent is a polar solvent, for example a polar protic solvent such as an alcohol, or a polar aprotic solvent such as acetone. Accordingly, in some cases, the method comprises a step of quenching the reaction by addition of a polar solvent.

Films of 2D material may be isolated by spin coating (the removal of solvent by rapidly spinning a dispersed sample to leave a thin film) or dip coating (immersing a substrate in a controlled manner in order to form a thin film of the material); by permeation chromatography or by other methods known in the art.

Additionally or alternatively, the method may further comprise the step of annealing the nanosheets to remove some or all of the dispersing medium molecules passivating the surface. The annealing step may be at a temperature of 350° C. or higher, 400° C. or higher, 450° C. or higher, for example around 500° C.

The present invention further provides dispersions of nanosheets obtainable according to a method of the first aspect.

The present invention further provides nanosheets obtainable according to a method of the first aspect.

In a further aspect, the present invention provides a composition comprising 2D metal chalcogenide nanosheets, wherein the variation in lateral dimension of the nanosheets is less than ±20%, preferably less than ±15%. In some cases, the variation in lateral dimension of the nanosheets is less than ±10%.

In some cases, the nanosheets may have a mean lateral dimension between 4.5 nm and 5.0 nm, between 5.0 nm and 5.5 nm, between 5.5 nm and 6.0 nm, between 6.0 nm and 6.5 nm, between 6.5 nm and 7.0 nm, between 7.0 nm and 7.5 nm, between 7.5 nm and 8.0 nm, between 8.0 nm and 8.5 nm, between 8.5 nm and 9.0 nm, between 9.0 nm and 9.5 nm, between 9.5 nm and 10.0 nm, between 10.0 nm and 10.5 nm, between 10.5 nm and 11.0 nm, between 11.5 nm and 12.0 nm, wherein the variation in lateral dimension of the nanosheets is less than ±20%, preferably less than ±15%. In some cases, the variation in lateral dimension of the nanosheets is less than ±10%.

In some cases, the nanosheets have a mean lateral dimension of about 5 nm, with a size distribution no more than ±20% of the mean lateral dimension, preferably no more than ±15 %.

In some cases, the nanosheets have a mean lateral dimension of about 7 nm, with a size distribution no more than ±20% of the mean lateral dimension, preferably no more than ±15 %.

In some cases, the nanosheets have a mean lateral dimension of about 9 nm, with a size distribution no more than ±20% of the mean lateral dimension, preferably no more than ±15 %.

In some cases, the nanosheets have a mean lateral dimension of about 11 nm, with a size distribution no more than ±20% of the mean lateral dimension, preferably no more than ±15 %.

In a further aspect, the invention provides a capacitor comprising 2D nanosheets as described herein. In some cases, the capacitor further comprises graphene. Suitably, the 2D nanosheets and graphene are combined to form a composite material. Accordingly, the invention may further provide a method of producing a 2D metal chalcogenide/graphene composite for use in a capacitor, the method comprising producing nanosheets according to the first aspect, the method including the step of annealing the nanosheets to remove some or all of the dispersing medium molecules passivating the surface; the method further comprising re-dispersing the annealed nanosheets in an organic solvent, combining the resultant dispersed annealed nanosheets with a graphene dispersion, and removing the solvent from the combined dispersion to form a composite.

A suitable organic solvent is N-methyl-2-pyrrolidone (NMP). Suitably, the ratio of 2D metal chalcogenide nanosheets to graphene is about 1:1 (w/w). Suitably, the combined dispersion is filtered to remove the solvent. The composite is left on the filter membrane. A suitable membrane is a polyvinylidene fluoride (PVDF) filter. Advantageously, a supported membrane is obtained without the need of any additional polymeric binders that are typically used in composite formation of this type.

It will be appreciated that all optional features and preferences are combinable, except where such a combination is expressly prohibited.

### BRIEF DESCRIPTION OF THE FIGURES

The invention will now be described with reference to the following figures in which:

FIG. 1 shows the typical nature of 1H-MoS₂@oleylamine flocculates on holey carbon grids. Images were obtained from 1H-MoS₂@oleylamine samples (a) 3, (b) 7 and (c) 15.

FIG. 2 shows TEM images of the 1H-MoS₂@oleylamine flocculates, giving evidence for the presence of monolayer MoS₂ nanosheets. The variation of the average nanosheet dimension from the reactions carried out at (a) 200° C. (sample 3; average size of 4.78±0.78 nm) and (b) 325° C. (sample 19; average size of 11.29±1.26 nm). The inserted images represent the SAED patterns, supporting the identification of the 1H-crystallites.

FIG. 3 shows the physical and spectroscopic properties of the MoS₂ nanosheets within 1H-MoS₂@oleylamine. (a) The lateral dimensions of the nanosheets produced (determined by statistical analyses of the TEM images obtained, with error bars) in relation to both reaction temperature and time. (b) A typical p-XRD diffraction pattern observed from the 1 H-MoS₂@oleylamine products (datum from sample 15), accompanied by a reference spectrum of MoS₂ (JCPDS card # 37-1492). (c) A typical Raman spectrum observed from the 1H-MoS₂@oleylamine products (datum from sample 7). (d) The correlation between A_{1g}-E_{2g} Raman bands separation of all samples produced and its average nanosheet size determined by TEM analysis.

FIG. 4 shows atomic resolution ADF STEM images of the side-on MoS₂ nanosheets in 1H-MoS₂@oleylamine (sample 19). (a) A region where plan view flakes were atomically resolved (with resolution of ˜0.15 nm) and some side-on flakes (indicated by arrows) were also present. The fact that no basal plane interlayer spacings are observed demonstrates these side-on flakes were monolayer. (b) Another region containing multiple side-on flakes, again all were monolayer.

FIG. 5 shows atomic resolution ADF STEM of MoS₂ nanosheets lying perpendicular to the electron beam. (a and b) Images showing that the flocculates in sample 19 were composed of a large number of nanosheets of a range of size and shapes, these sheets have lateral dimensions of only a few nanometres. Inset FTs show polycrystalline ring patterns, demonstrating that a wide range of crystallographic orientations were present within the scan area. (c and d) Enlarged areas (indicated by red boxes in a and b) allowing sheets' shape and crystallinity to be more easily observed.

FIG. 6 shows (a) ADF image of a MoS₂ flocculate from sample 19, a STEM EDX spectrum image was acquired from the area indicated by the red box. (b and c) show the resulting Mo and S elemental maps extracted from the spectrum image (using the S K-series (2.31 keV) and Mo K-series (17.48 keV)), demonstrating uniform distributions of both elements.

FIG. 7 shows the proposed decomposition pathways of the molybdenum(V) complexes (Ia-c, IIb-c) to MoS₂.

FIG. 8 shows a representative thermogram for the decomposition of 1 H-MoS_{2@}oleylamine (sample 16) in air. The temperatures that initiate the decomposition of the components within the materials are included in red (vertical lines).

FIG. 9 shows a) Photograph of constructed coin cell (CR2032) showing an exploded schematic of the cell architecture. Photograph showing the MoS₂/graphene composite on the flexible supporting membrane (i) along with optical microscope image (×100) of the membrane surface (ii). The PVDF membranes are stacked back-to-back providing direct electrical contact between the active material and the current collector. The cells were filled with aqueous electrolyte (1M Na₂SO₄). b) Cyclic voltammograms with increasing scan rates for the MoS_{2/}graphene composite symmetrical coin showing double-layer behaviour. Scan rates starting from the centre and moving outwards are 10, 20, 40, 80, 100, 150, 200, 250, and 300 mV/s. c) Galvanostatic discharge curves at different current densities. Inset shows the calculated specific capacitance as a function of current density. d) The measured specific capacitance.

FIG. 10 shows the Nyquist plot of the real (Z′) and complex (Z″) impedance of the coin cell. The semi-circle at the high frequency region is due to ion diffusion while at low frequencies more capacitive behaviour dominates. The equivalent series resistance (ESR) for the membrane is 1.39 Ω.

FIG. 11 shows TEM images of WS₂ nanosheets produced at 325° C. The image shows monolayer and bilayer, and the inserted diffraction lines indicate the (002) spacing in the bilayer sheets observed (˜0.68 nm).

FIG. 12 shows a TEM image of (Mo_{0.78}W_{0.22})S₂@oleylamine produced at 325° C.

FIG. 13 shows atomic resolution HAADF STEM images of a ternary (MoₓW₁₋ₓ)S₂@oleylamine product. (a) shows a region containing multiple flakes, the ring pattern of the inset Fourier transform (FT) is consistent with multiple randomly oriented crystalline flakes. (b-d) show a higher magnification images of monolayer flakes, FTs show the flakes to be single crystals and the locations of bright atoms is consistent with W substitution into Mo lattice in the 1H-MoS₂ lattice.

FIG. 14 shows HAADF STEM images of the (MoₓW₁₋ₓ)S₂@oleylamine product of run 8 revealing an average W doping level of 25.98%. (a) and (c) show enlarged HAADF STEM images of regions of the flake. (b) shows HAADF intensity linescan extracted from the row of atoms indicated by the dashed box in (a), the high intensity of the final two atoms in the row are consistent with the W atoms while the intensity of the remaining atoms are assigned to Mo. Atomic identification based on HAADF intensity is illustrated in (c) and (d), with W atoms highlighted in by dark colouring and Mo atoms in brighter colouring.

FIG. 15 shows diffraction patterns for (MoₓW₁₋ₓ)S₂@oleylamine produced.

FIG. 16 shows a stacked Raman spectra of (MoₓW₁₋ₓ)S₂ nanosheets (all in the 5-6 nm range) produced with differing compositions and (right) the band shifts of the E_{2g} and A_{1g} signals, with respect to composition, observed in the Raman spectra.

FIG. 17 shows high-resolution TEM images of (TM)-doped MoS₂@oleylamine (Left) 12% Cu-doped MoS₂@oleylamine (arrows highlight the presence of bi/multilayer domains. (Right) 13% Co-doped monolayer MoS₂@oleylamine.

FIG. 18 shows Raman spectra of pure MoS₂ and Co-doped MoS₂. The observed A_{1g}-E_{2g} band separation versus dopant metal and dopant concentration (greyed area represent the range of separations measured for 10 samples of 1H-MoS₂).

FIG. 19 shows XRD patterns of Ni-doped MoS₂—dataset smoothed for clarity.

### DETAILED DESCRIPTION

The invention provides a one-pot synthetic route, based on hot injection-thermolysis, for the production of pure, high quality MoS₂ nanosheets capped by oleylamine. Of course, other nanosheets as described herein are also envisioned. Nanometre-scale control over the lateral dimensions of 1H-MoS₂ nanosheets (ranging from 4.5 to 11.5 nm), has been achieved by modulation of the reaction temperature (between 200 to 325° C.) whilst maintaining consistent levels of purity and oleylamine capping. In addition, the first atomic resolution STEM imaging of this class of materials gives new insights into the structure of MoS₂ within the oleylamine matrix. Specifically, the inventors have shown that monolayer, highly crystalline and randomly oriented nanosheets were formed. The high purity of monolayer sheets, combined with small flake size was demonstrated to be ideal for energy storage applications such as supercapacitors. The calculated specific capacitance (of up to 50 mF/cm²) was significantly larger than previously reported from ultrasonication prepared MoS₂, and can be maximised through further optimisation. These results indicate that composites of well-defined and thoroughly characterized 2D materials, such as MoS₂ and graphene, show increasing promise for wide scale electrochemical energy storage applications.

The invention produces nanosheets. The term nanosheet as used in the art refers to two-dimensional nanostructures with a thickness on the nanometer scale. The thickness may be very small, with some monolayer nanosheets consisting of a single layer of atoms. For example, graphene is a nanosheet. Nanosheets are one type of nanomaterial. Other nanomaterials include nanotubes and nanorods (often referred to as 1D structures) and nanoparticles, for example quantum dots (sometimes referred to as 0D structures).

Nanosheets are typically described as having diameter:length aspect ratios close to about 1:1, although some variation in this is of course envisaged. By contrast, nanorods and nanowires typically have an aspect ratio of at least 1:10. Nanosheet, as used herein, may refer to a nanostructure having a diameter:length aspect ratio of 2:1 to 1:2, preferably 1.5:1 to 1:1.5, most preferably about 1:1.

The following relates to the complex [Mo₂O₂S₂(S₂COEt)₂] in the production of 1H-MoS₂@oleylamine . It will be appreciated that other complexes as described herein may be used.

1H-MoS₂@oleylamine samples were prepared by the decomposition of [Mo₂O₂S₂(S₂COEt)₂] in oleylamine via a hot injection-thermolysis method.^{[1]} Reactions were carried out at temperatures ranging from 200 to 325° C. to produce black materials. Aliquots were taken at regular intervals and the reaction products isolated, by repeated ethanol washing and centrifugation steps. Upon injection, decomposition of the precursor occurs rapidly; there was no evidence of unreacted [Mo₂O₂S₂(S₂COEt)₂] within the products or the supernatants, even with the short reaction times used at most temperatures (e.g. 3 minutes at 250° C.). The only exception was at 3 minutes at the lowest temperature studied (200° C.; sample 1). The supernatant in this case contained a small amount of the unreacted precursor, giving it a brown hue. In methanolic suspensions, all 1H-MoS₂@oleylamine samples consisted of black flocculates. Once isolated and dried most of the products were obtained as brittle solids, although the inventors found that a significant increase in both the reaction time and temperature could lead to the isolation of greasier materials (i.e. 16, 19 and 20; see Table 1).

The nature of oleylamine coordination in all 1H-MoS₂@oleylamine products was determined by (ATR) FT-IR spectroscopy. A number of signals indicated the presence of oleylamine (2850-3000 cm⁻¹, 1647 cm⁻¹ and 1468 cm⁻ for v(C—H), v(C═C) and δ(C—H) modes, respectively), but the absence of a signal at 3319 cm⁻ and the significantly reduced peak at 1560 cm⁻ (representative of v[N—H] and δ[H—N—H] of free oleylamine, respectively) is noted.

These observations have previously been used as an indicator for oleylamine capping in a variety of nanoparticles,^{[2]} as well as for MoS₂ nanosheets,^{[3]} and implies that the oleylamine present is chemically bound to the 1H-MoS₂ nanosheet.

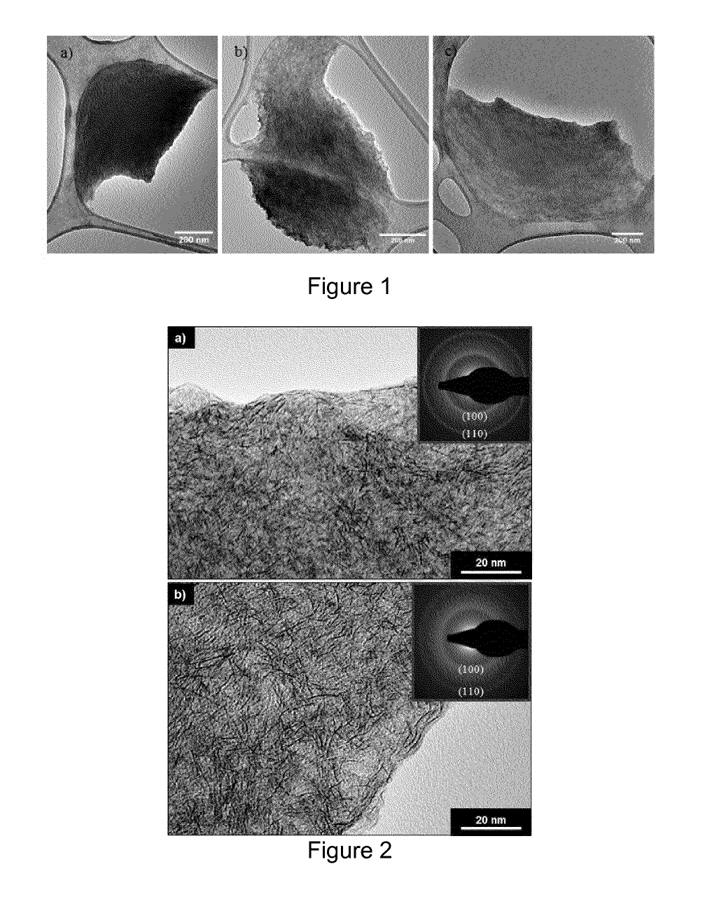

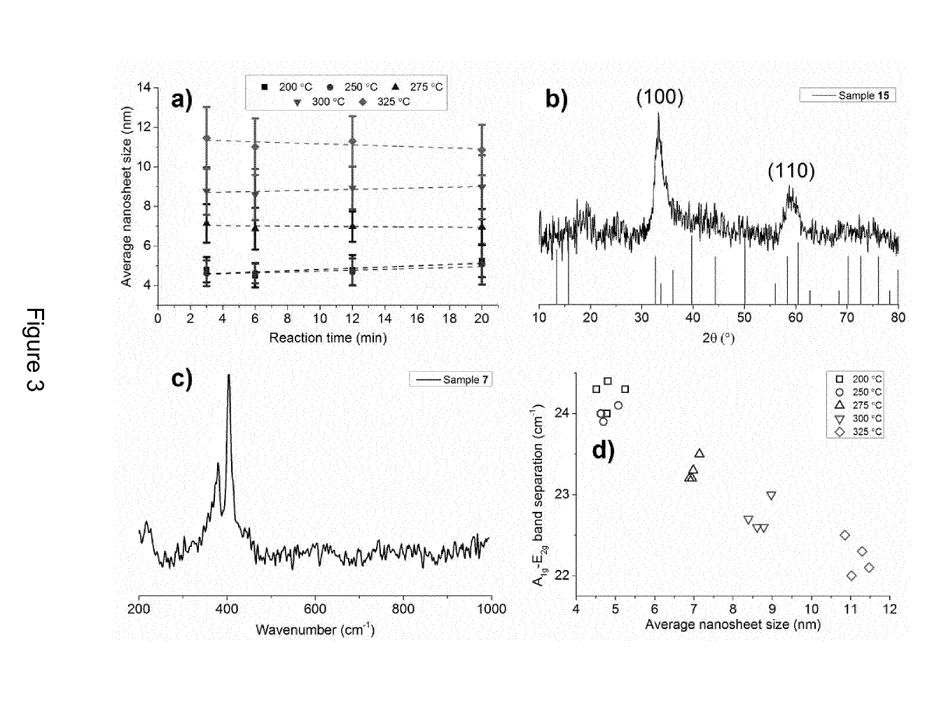

TEM analysis shows that all of the 1H-MoS₂@oleylamine products consist of small MoS₂ nanosheets which form highly disordered, aggregated structures. These flocculates typically have lateral dimensions from 100's to 1000's of nm and are commonly found to both adhere to and mould around the carbon film on lacey carbon TEM grids (FIG. 1). On performing high resolution TEM imaging of the flocculates (FIG. 2a-b), it is clear that the MoS₂ nanosheets are randomly oriented; with the strongest phase contrast observed for nanosheets with their basal planes oriented parallel to the incident electron beam.^{[3,4]} The dimensions of the MoS₂ nanosheets within each of the 1H-MoS₂@oleylamine samples was estimated by statistical analysis of the basal plane dimensions observed for side-on monolayer nanosheets seen in the TEM images (sample size in each study: N=40). This analysis revealed that the lateral sizes of the nanosheets can be controlled by the selection of reaction temperature (Table 1 and FIG. 3a). The low temperature reactions at 200 and 250° C. produced MoS₂ nanosheets within the 1H-MoS₂@oleylamine with an approximate lateral size of 4.5-5 nm, whereas the gradual increase of the reaction temperature above 250° C. promoted the growth of larger nanosheets of up to an average of ca. 11.5 nm at 325° C. These observations suggest a non-classical crystal growth mechanism is prevalent in the formation of the MoS₂ nanosheets.^{[5]} In all cases, the deviation of the nanosheets measured never exceeds ±15% of the mean nanosheet length, showing a significantly increased level of control in the growth of the nanoscale-MoS₂ monolayers, compared to other known processes where little-to-no control is observed.PA Nanosheet sizes appear to be unaffected by the reaction times employed; a survey of the aliquots obtained from the same hot injection reactions at 3 and 20 minutes intervals showed no significant size variations, suggesting that in all samples the nanosheet growth process is complete in under 3 minutes.

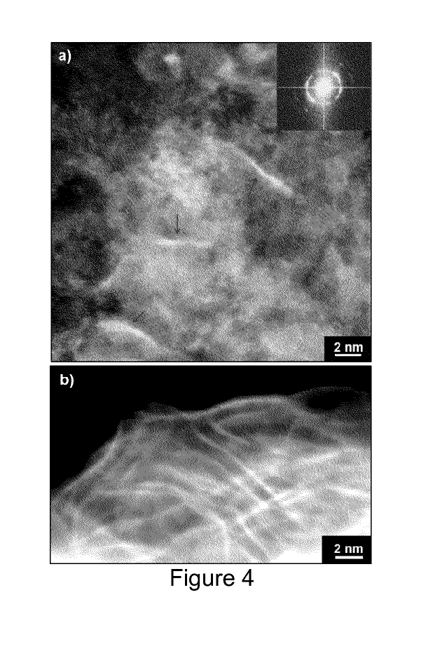

A probe side aberration-corrected STEM was used to perform high resolution annular dark field (ADF) imaging of the flocculate structure for sample 19 (synthesised at 325° C. for 12 minutes). The atomic resolution ADF images in FIG. 4 support the microstructures seen in the TEM images, showing structures comprised of large numbers of randomly oriented MoS₂ nanosheets. STEM imaging of side-on MoS₂ nanosheets allows precise determination of the number of layers in an individual flake,^{[6]} the side-on flakes seen in our atomic resolution images show no multilayer structures. The Fourier transforms (FTs) of the atomic resolution images show the 0.27 nm spacing of the (100) planes (insert in FIG. 4a) but there is was no evidence of the considerably larger (002) interlayer spacing (0.62 nm) expected for bi- and multilayer structures. It is therefore believed that the flocculates are comprised exclusively of monolayer MoS₂ nanosheets; multilayer flakes either are extremely rare or entirely absent from these samples. This observation is consistent with the TEM selected-area electron diffraction patterns (SAED) and the p-XRD patterns, which both display highly broadened bands for the (100) and (110) crystal planes of MoS₂ in the 1H-phase (in addition to a broadened signal at approx. 20° for the reflections of the glass substrate in the p-XRD spectra; FIGS. 2a (insert), 2b (insert) and 3b). There were no discernible bands corresponding to the (002) reflection at ca. 14° from either diffraction experiment.^{[7]}

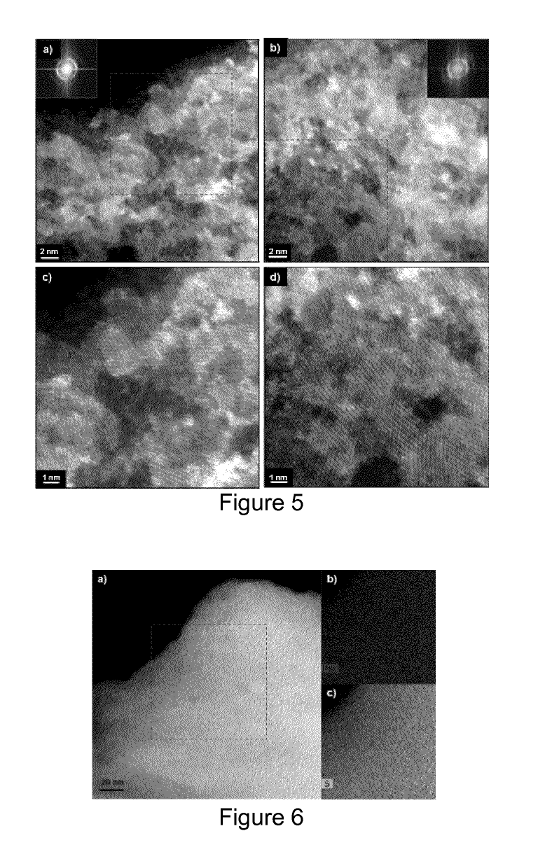

In ADF STEM images of sample 19, occasional flakes were favourably oriented with their basal planes normal to the optic axis allowing them to be imaged with atomic resolution. Even within relatively small scan areas (for example the 25×25 nm area shown in FIG. 5) FTs of the atomic resolution images revealed ring like patterns characteristic of a polycrystalline material (with ring radius corresponding to the 0.27 nm d-spacing of the {100} planes), as opposed to the distinct spot patterns present when imaging individual isolated nanocrystals. Closer inspection of the images shows small nanosheets randomly oriented with respect to their neighbours and often overlapping one another. The lateral dimensions of the sheets seen in these images are consistent with the sizes determined from TEM imaging.

The STEM was also used to perform energy dispersive X-ray (EDX) spectrum imaging on flocculates, allowing chemical composition to be probed with nanometre resolution. FIG. 6 shows a spectrum image of a typical region of flocculate from sample 19. The resulting elemental maps reveal homogeneous distributions of Mo and S. It should be noted that the S Kα (2.31 keV) and Mo Lα (2.29 keV) peaks overlap making deconvoltion on a pixel by pixel basis challenging. The summed EDX spectra suggests that the MoS₂ is pure, with all other elements seen in the spectrum associated with the TEM support (C, Si, O, Cu). Quantification of the summed spectra using a standardless Cliff-Lorimer approach supports the expected Mo:S stoichiometry of 1:2.

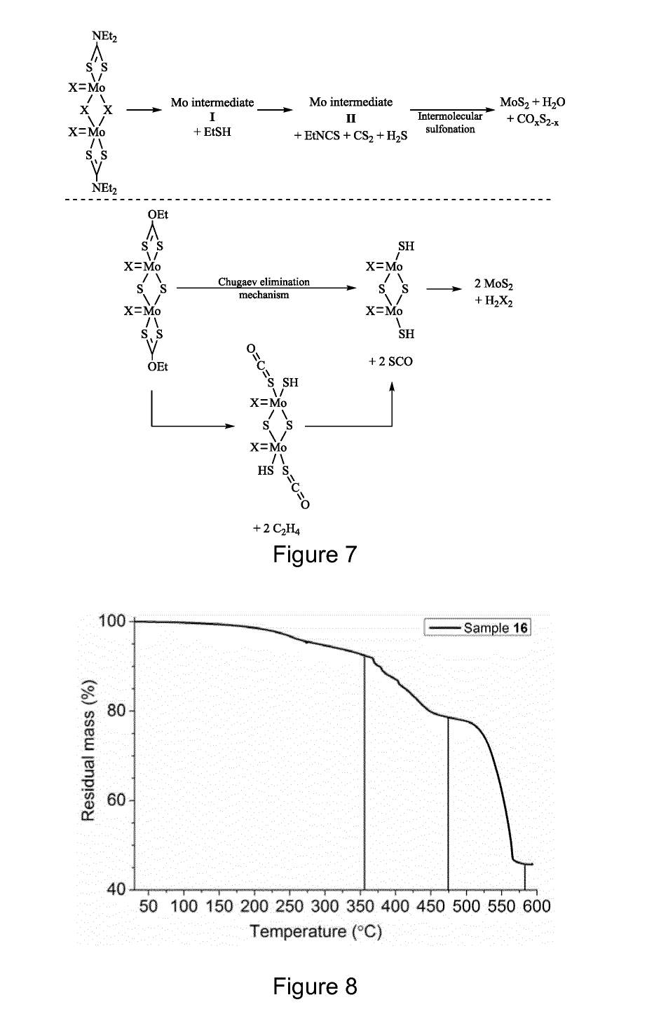

The only defined Raman-peaks in all samples were that of the A_{1g} and E_{2g} bands of MoS₂; no other identifiable signals were observed in the 200-1000 cm⁻¹ range. This supports the expected decomposition mechanism of such xanthate-bearing complexes to MoS₂, even in the presence of oxo-groups (FIG. 7).^{[8]} Raman spectroscopy of large MoS₂ nanosheets (lateral dimensions >100 nm) is regularly used to estimate nanosheet thicknesses of these materials, as the A_{1g} and E_{2g} bands are known to exhibit a well-defined dependence on layer thickness.^{[9]} However, Raman analysis of 1H-MoS₂@oleylamine does not show the expected peak separation of 18 cm⁻ for single layer MoS₂, instead showing band separations which depend upon the lateral sizes of nanosheets in the 1H-MoS₂@oleylamine (FIG. 3c-d and Table 1). The peak separation from the samples obtained at 200 and 250° C. (average nanosheet size measured by TEM ˜4.8 nm) was approximately 24 cm⁻¹. This separation narrowed upon increasing reaction temperature, falling to ca. 22 cm⁻¹ for samples prepared at 325° C. (average nanosheet size measured by TEM ˜11.3 nm). The expansion of the A_{1g} to E_{2g} bands separation, as a consequence of the lateral dimensions of single-layer nanosheets being ≤100 nm, is thought to occur due to the quantum confinement of the crystal structure within the 2D-plane. This phenomenon has previously been observed in both MoS₂ nanosheets and fullerene-like nanoparticles.^{[10]}

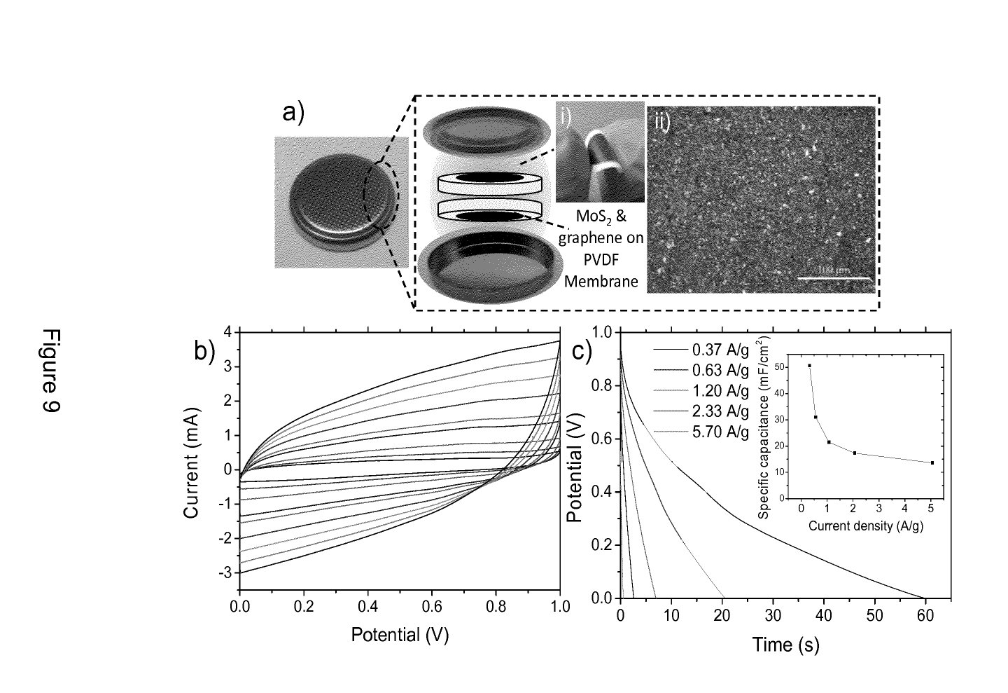

To confirm both the purities and the compositions of the products, the dried 1H-MoS₂@oleylamine samples were subjected to TGA (10° C./min, up to 600° C. in 1 atm. air; an example thermogram is shown in FIG. 8). All the thermograms obtained display the same three stages of decomposition, previously described by Altavilla et al:^{[3]} Stage 1 (30-360° C.)—the oxidation of surface sulfur impurities on the 1H-MoS₂@oleylamine, Stage 2 (360-475° C.)—the decomposition of physisorbed oleylamine, Stage 3 (475-580° C.)—the decomposition of chemisorbed oleylamine and the oxidation of MoS₂. The remaining residue at the end of each stage (termed m_{Tn}) were: 1H-MoS₂@oleylamine and physisorbed oleylamine at 360° C. (m_{T1}), 1H-MoS₂@oleylamine at 475° C. (m^{T2}) and MoO₃ at 580° C. (m_{T3}).

The inventors have devised a simplified set of calculations to approximate both the purities and the component ratios of the 1H-MoS₂@oleylamine products from their TGA data. This is the first time this class of materials have been compositionally analysed to such a level. The purity of the isolated materials were determined simply from the residual mass of the residues at 475° C. (m_{T2}) with respect to the initial mass, whereas to calculate the composition of 1H-MoS₂@oleylamine the inventors have simplified the calculations to Equation 1 (detailed calculations shown in SI, the values obtained are in Table 1):

$$1 H - {MoS}_{2} @ {oleylamine}_{x} , \\ where x = 0.545 \frac{{m}_{{T}_{2}}}{{m}_{{T}_{2}}} - 0.605 \qquad ( 1 )$$

From the calculations, the 1H-MoS₂@oleylamine products produced from the 200, 250 and 275° C. reactions were reasonably pure (in the region of 68-75%; the impurities consisting of surface sulfur adatoms and physisorbed oleylamine), with a composition of MoS₂.Oleylamine_{0.28-0.32}. Similar purities and compositions of the 1H-MoS₂@oleylamine products were observed for the 300 and 325° C. reactions at the shorter reaction times, but prolonging the reactions was found to increase the amount of chemisorbed oleylamine, as demonstrated by samples 16, 19 and 20, probably contributing to the oily appearance of the products. These factors resulted in a significant decrease of overall purity due to an increase of both surface sulfur impurities and physisorbed oleylamine present within the greasier materials formed at longer reaction times.

To demonstrate the applicability of this material for use in electrochemical energy storage applications, symmetrical coin-cell type (CR2032) supercapacitors were constructed using a composite of the 1H-MoS2@oleylamine (flake size approx. 8 nm) combined with graphene as a conductive additive to overcome the inherent resistivity of the semiconducting MoS2 flakes, and analysed using best practice methods.^{[11]} The oleylamine was removed from the MoS₂ first by thermal annealing (500° C.), the resulting crystals were re-dispersed in an organic solvent (N-methyl-2-pyrrolidone, NMP) and combined with a graphene dispersion, also prepared by liquid-exfoliation, in a 1:1 (w/w) ratio. This method of graphene production is known to produce large amounts of few layer flakes (1-5 layers) with lateral dimensions of 1-5 μm.^{[12]} This composite dispersion was then filtered through a polyvinylidene fluoride (PVDF) filter to form a supported membrane without the need of any additional polymeric binders that are typically used.^{[13]} The mass of active material was approximately 1 mg (mass loading of 1 mg/cm²) which produces a mechanically flexible and stable thin film with a thickness of ≈5 μm. These composite membranes were then stacked together in a symmetrical coin cell arrangement, as demonstrated previously for ultrasonication exfoliated Mos₂.^{[14,15]}

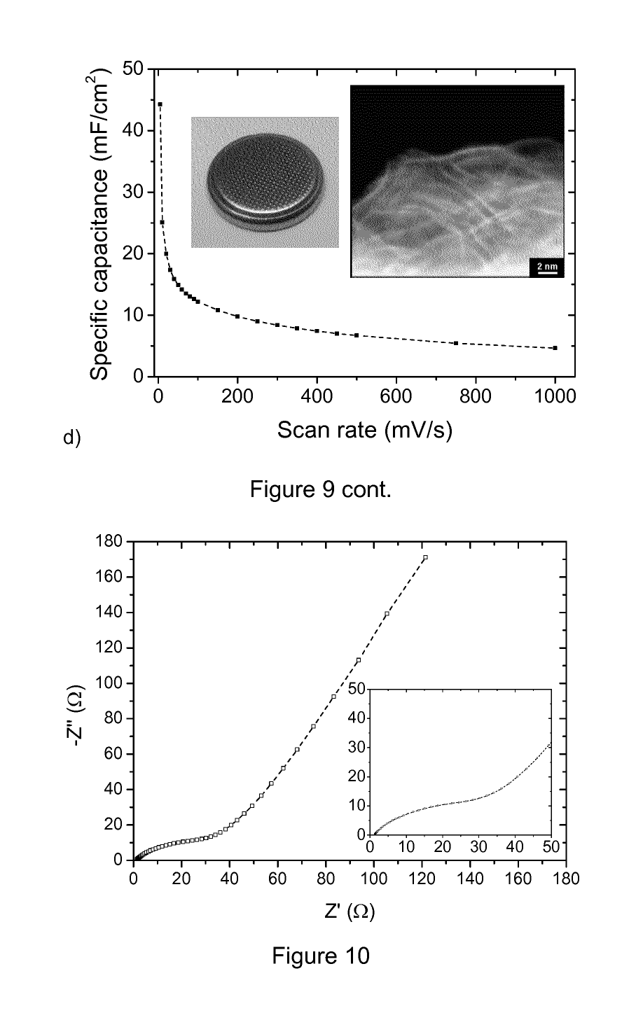

FIG. 9 shows schematically the design of the coin cell as well as a photograph of the MoS₂/composite membrane and electrochemical response of the membrane using an aqueous electrolyte (1 M Na₂SO₄). In the optical microscope image (FIG. 9a), several larger graphite flakes are visible, and with further optimisation of the exfoliation the capacitance values could be further improved. In FIG. 9b the cyclic voltammetry (CV) at differing scan rates is shown. At low scan rates the CV curves exhibit the expected ‘square’ shape of an ideal electrochemical double-layer capacitor (EDLC) with no discernible pseudocapacitance peaks; however as the scan rate increases the curves deviate from the ideal shape and this indicates a change in the charge storage mechanism to surface mediated ion adsorption.^{[16, 17]} FIG. 9c shows the galvanostatic discharge curves for the cell with increasing current densities, along with the calculated specific capacitance (Cₛₚ, FIG. 9c inset). The non-linearity of the discharge curve at higher current density indicates a deviation from ideal EDLC behaviour and can be attributed to surface ion adsorption as an alternate charge storage mechanism in agreement with the CV results. The maximum value of Cₛₚ was calculated to be 50.65 mF/cm² (current density of 0.37 Ng); this compares impressively with previously reported results from ultrasonication exfoliated MoS₂ which range between 3-14 mF/cm².^{[14,16,18]} This large increase is attributed to the small MoS₂ flake dimensions used in this synthesis method compared to solution exfoliated material, whose dimensions ranges from several hundred nanometres to microns.^{[19]} The small flake dimensions lead to a maximum in the available surface area, providing a high density of highly reactive edge sites which can increase the available sites for ion adsorption and accumulation on the surface.^{[20]} Combined with the small lateral dimensions the synthesized MoS₂ nanosheets are exclusively monolayer, as discussed previously. Despite some restacking that will occur during filtration, the monolayer nature of the flakes will maximise the available surface area and provide a maximum specific capacitance per unit area when compared to thicker less well defined material. The decrease in Cₛₚwith increasing current density indicates that the charge storage mechanism of the MoS₂/graphene composite is not purely a double-layer effect due to the internal resistance of the membrane. This is in agreement with the measured impedance response of the cell at high frequencies (FIG. 10). However, by optimising the ratio of graphene to MoS₂ it may be possible to overcome this and maximise the power density while still maintaining the high energy density that the MoS₂ composite provides.

Impedance spectroscopy is a powerful tool as it allows the user to determine what processes are occurring at the electrode-electrolyte interface, which is crucial in understanding device performance. Supercapacitors oscillate between two states depending on the frequency, ideally exhibiting resistive behaviour at high frequencies and capacitance at low frequencies.^{[21]} At low frequency the imaginary component of the complex impedance sharply increases tending towards a vertical line with a phase of 90°, indicative of ideal double-layer capacitive behaviour. In the middle frequency range the response is dominated by the electrode porosity and diffusion of the electrolyte ions; in this range the thickness of the electrode layer causes a shift towards more resistive behaviour for thicker active material. While all of the power is dissipated at high frequency, where the cell behaves like a pure resistor, matching the inventors' observations of the impedance response of the cell.

While the foregoing description has focussed on MoS₂ as the produced TDC, as described herein the invention encompasses other metals.

For example, the inventors have demonstrated the production of WS₂ nanosheets as follows. The complexes of WS(S₂)(S₂CNR₂)₂ (R₂=Et₂[1], =ⁱPr₂ [2], =MeHex [3]) were used in the hot injection reaction as described herein (300° C., 10 mins). The sizes of the nanosheets produced were imaged by TEM: [1]−7.61±0.98 nm, [2]−6.78±1.24 nm, [3]−7.50±1.19 nm. All show signs of some bilayer sheets, but a significant increase in those seen in [3].

The inventors have further demonstrated the synthesis of ReS₂ nanosheets. The complexes of Re(S₃CNEt₂)(S₂CNR₂)₃ [1] and Re₂O₃(S₂CNEt₂)₄ [2] was used in the hot injection reaction (300° C., 10 mins), resulting in the production of nanosheet like shapes (seen by TEM). The sizes of the nanosheets produced were imaged by TEM: [1]−4.49±0.67 nm, [2]−5.80 ±0.77 nm. All appear to be monolayer sheets, with no sign of bi- or multilayers.

As described herein, the invention also provides ternary structures. The inventors have demonstrated the applicability of the method to ternary structures such as (MoₓW₁₋ₓ)S₂@oleylamine. As described herein, these may be produced by using a mixture of precursors.

By way of example, (MoₓW₁₋ₓ)S₂@oleylamine samples were prepared by hot injection thermolysis. A mixture of [Mo₂O₂S₂(S₂CNEt₂)₂] and [W₂S₄(S₂CNEt₂)₂].H₂O (total 0.50 mmol metal content) in oleylamine was injected into hot oleylamine (Table 2). Reactions were carried out at temperatures ranging from 250 to 325° C. to produce dark-coloured suspensions. The reaction was quenched after 10 minutes, before isolating and purifying by repeated ethanol washing and centrifugation steps. In the binary reactions (i.e. the reaction of solely [Mo₂O₂S₂(S₂CNEt₂)₂] and [W₂S₄(S2CNEt2)₂].H₂O) the decomposition of the precursors occurs rapidly; there was no evidence of unreacted materials within the products or the supernatants after reacting for 4 minutes. Most of the dried MoS₂- and WS_{2@}oleylamine products were obtained as brittle solids, the only exception was for the MoS_{2@}oleylamine produced at 325° C., which yielded a greasy material, similar to those observed in the formation of MoS₂@oleylamine. However, the WS₂@oleylamine produced at the same temperature was found to be a non-greasy, brittle solid. In turn, the ternary (MoₓW₁₋ₓ)S₂@oleylamine samples, prepared by the decomposition of mixtures of [Mo₂O₂S₂(S₂CNEt₂)₂] and [W₂S₄(S₂CNEt₂)₂].H₂O at 250-325° C., also gave brittle dark-coloured solids.

To determine the metal content in the (MoₓW₁₋ₓ)S₂@oleylamine produced, inductively coupled plasma optical emission spectrometry (ICP-OES) was utilised. ICP-OES found that the metal content of the products had a Mo-to-W ratio that closely matches that of the initial precursor ratios used in the reaction, with a maximum variation of only x<0.05; Runs 1-4 and 17-20 showed exclusively the native metals employed, with the runs 5-8, 9-12 and 13-17 giving compositions of approximately 0.75:0.25, 0.50:0.50 and 0.25:0.75 (w.r.t. the Mo/W ratio), respectively. There appears to be a slight variation in the composition, depending on the temperature employed: at 250° C., the materials produced appeared to be slightly molybdenum rich—an indication that the tungsten precursor may not decompose completely in the reaction. On the other hand, at 325° C. the Mo/W ratios are the closest to the expected value, indicating a homogeneous decomposition process with the two precursors.

TEM analyses show that the binary MoS₂@oleylamine (Runs 1-4) and WS₂@oleylamine (Runs 17-20) materials consist of small MS₂ nanosheets which form highly disordered, aggregated structures that are 100's to 1000's of nm in size. High resolution TEM imaging show the expected randomly oriented monolayer MoS₂ and WS₂ nanosheets within the aggregates; the strongest phase contrasts were observed for nanosheets with their basal planes oriented parallel to the incident electron beam.

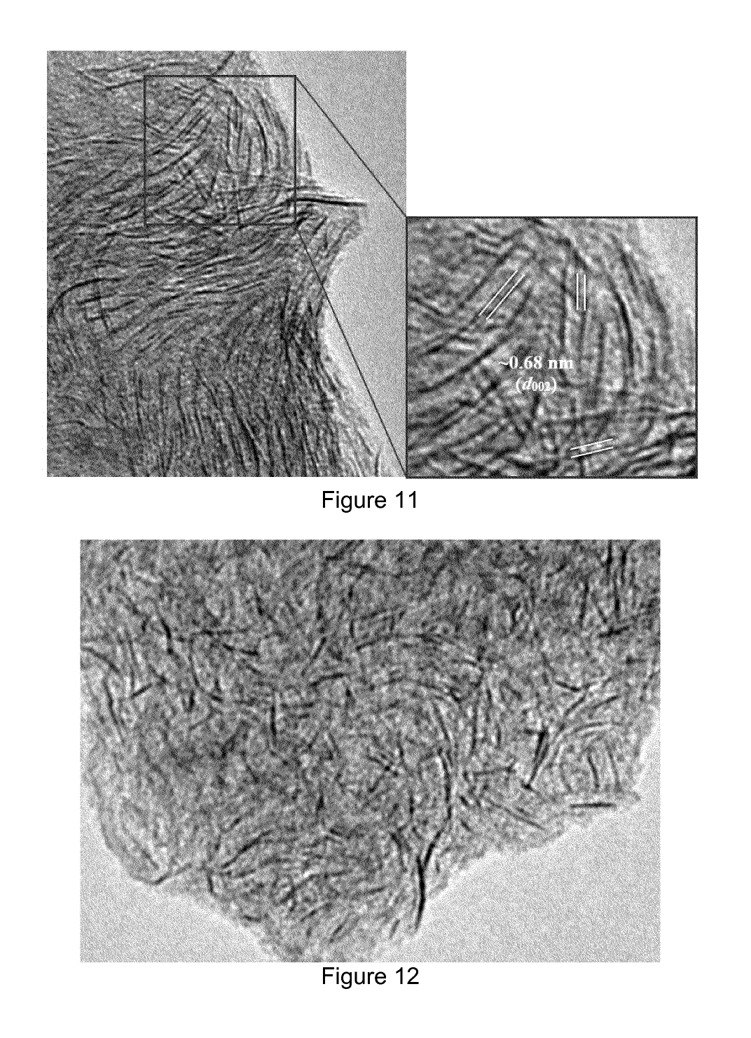

The dimensions of the MS₂ nanosheets within each of the MS₂@oleylamine samples was estimated by statistical analysis of the basal plane dimensions observed for side-on monolayer nanosheets seen in the TEM images shown in FIGS. 11 and 12 (sample size in each study: N=40). The lateral sizes of the nanosheets produced is dictated by the reaction temperature, with higher temperatures producing larger MoS₂ and WS₂ nanosheets (7.72 and 10.56 nm, respectively at 325° C.) than those at 250° C. (4.03 and 4.17 nm, respectively). In general, the WS₂ nanosheets are slightly larger than the MoS₂ nanosheets, all other things being equal. The non-classical crystal growth process observed follows that seen in the hot-injection of Mo₂O₂S₂(S₂COEt)₂ In most cases, the deviation of the nanosheets measured never exceeds±15% of the mean nanosheet length (in the case of [W₂S₄(S₂CNEt₂)₂].H₂O at high temperatures (325° C.) the lateral dimensions deviates by a little more: up to 25%).

In addition, the images of the WS₂@oleylamine prepared at 275, 300 and 325° C. (Runs 6, 7 and 8, respectively) show that an increasing amount of bilayer nanosheets present. The interlayer spacings of ca. 0.68 confirm that the bilayers (and any other multilayers) are stacked in the absence of an oleylamine intercalatant layer.

Statistical analyses of the dimensions in (MoₓW₁₋ₓ)S₂@oleylamine (Runs 5-16) were also carried out. The materials produced in runs 5-8 (with a Mo:W precursor loadings of ˜0.75:0.25) follow the observations from the binary materials, with a gradual increase of nanosheet size when higher temperatures were employed. In the cases of runs 9-12 (Mo:W ratio ˜0.5:0.5) and 13-16 (Mo:W ratio ˜0.25:0.75) the growth of the nanosheets do not linearly increase with increasing reaction temperatures; the lateral dimensions of the nanosheets produced at 325° C. are smaller than those produced at 300° C. A small but non-negligible number of bilayer sheets was also observed in both ratios at higher temperature (325° C.).

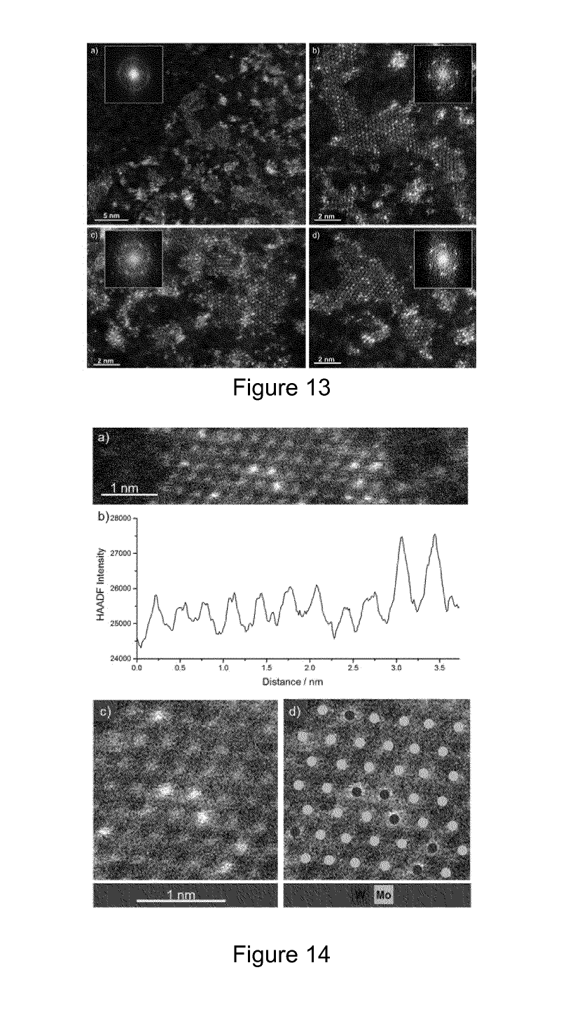

Atomic resolution high angle annular dark field (HAADF) scanning transmission electron microscope (STEM) imaging shows crystalline monolayer flakes with W atoms directly substituted into Mo lattice sites in the 1H-MoS₂ crystal structure (FIG. 13). The contrast mechanism in HAADF STEM imaging is strongly dependent on atomic number (Z). Consequently, in monolayer regions of 2D materials, atoms with different Z are distinguishable by atomic resolution HAADF STEM imaging. Due the significant difference in atomic numbers of Mo and W (Mo=42, W=74) the two elements can be clearly distinguished with W atoms appearing significantly brighter (FIG. 14). The bright W atoms appear to be randomly distributed across the flakes imaged, showing no evidence of clustering. Due to the contrast difference between Mo and W it is possible to determine the Mo:W ratio of individual flakes by atom counting. 10 regions of monolayer material were identified in images of sample 8 and their composition quantified by atom counting; in total 1501 atoms were counted revealing 25.98% W substitution, a value that is close to that found by bulk characterisation of the same sample (ca. 22%). Substitution levels show some inhomogeneity on a flake-by-flake basis, with the flakes measured ranging in composition from 18.5% to 32% W, such a spread in compositions is unsurprising given the small lateral dimensions of the flakes investigated. Quantitative energy dispersive X-ray (EDX) spectroscopy of the same sample reveals compositions in good agreement with the atom counting results, showing ˜25% W inclusion. EDX spectrum imaging of aggregated regions of flakes showing homogeneous co-localisation of Mo and Won the sub-10 nm level.

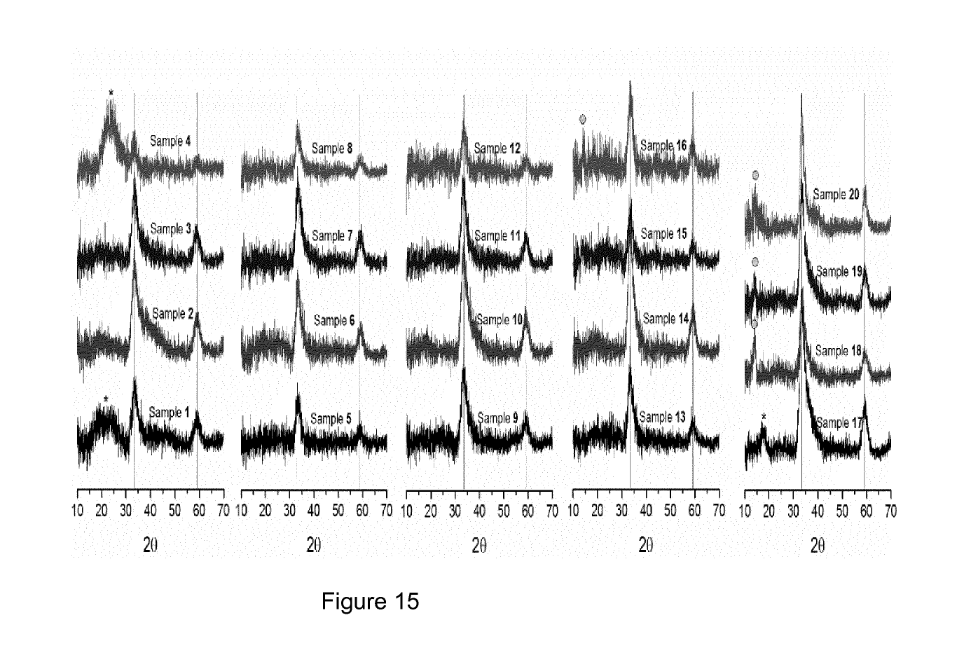

Thin films were prepared by drop-casting MS₂@oleylamine dispersions onto glass substrates. Grazing incidence-XRD of films of all of the MS₂@oleylamine samples, irrespective of the Mo/W ratio, displayed diffraction patterns that closely resemble each other: all spectra display highly broadened bands for the (100) and (110) crystal planes of the layered TMDC in the 1H-phase (FIG. 15). The spectra of runs 12, 16, 18, 19 and 20 show an additional, poorly-defined band at approx. 14°, corresponding to the interlayer MS₂ (002) band. This confirms the presence of some bilayer structures observed in these samples via TEM.

To compare the catalytic behaviour of the different compounds (MoₓW₁₋ₓ)S₂ dispersions were produced, after removal of the oleylamine by annealing and re-dispersion in NMP by ultrasonication. These different dispersions were then diluted in isopropanol before drop casting onto a glassy carbon electrode for hydrogen evolution reactions (HER). HER electrocatalysis was performed in constantly stirred and thoroughly degassed aqueous 1 M H₂SO₄ with differing catalyst loadings and compared to the performance of the bare glassy carbon and a platinum mesh. A silver/silver chloride reference electrode was used and the potentials have been corrected to the SHE, no iR compensation was used. To maximise the number of exposed catalytically active edge sites and to minimise flake restacking very low mass loadings were used (˜0.1 μg/cm²). Changing of the mass loadings was done by taking 10 μl aliquots of the diluted (MoₓW₁₋ₓ)S₂ dispersions and repeatedly drop casting onto the glassy carbon electrode and leaving to dry in air. The mass loadings used were determined from the absorbance spectroscopy of the starting dispersions and subsequent dilution. The bare glassy carbon electrode displayed poor catalytic performance with overpotential (q) of ˜400 mV, compared to the platinum mesh which is known to be an excellent HER catalyst with η of ˜40 mV. After drop casting of the (MoₓW₁₋ₓ)S₂flakes there was a significant improvement in electrocatalytic performance compared to the bare glassy carbon, even for the low catalyst loadings. Of the deposited TMDC materials the lowest n was the pure MoS₂, while the highest was the pure WS₂, and each of the differing compositions were evenly spread between these depending on their Mo content. Table 3 shows the n values for each of the different (MoₓW₁₋ₓ)S₂dispersions, as well as the Tafel slopes, and the measured current densities at 0.6 V. At potentials much greater than the η there is an increasing current density with Mo content, with the ratio of current increase matching closely to the stoichiometric ratio of the Mo determined earlier. The electrocatalytic activity of these alloyed materials is similar to recently demonstrated MoS_{2/}WS₂ heterostructures which were produced by a CVD process.

TABLE 3
Overpotential, calculated Tafel slope, and current density of the bare
glassy carbon and platinum as well as for each of the nanoflake-
modified electrodes.

| | | | Current density |
|---|---|---|---|
| | Overpotential | Tafel slope | @ 600 mV |
| Sample | (η, mV) | (mV/dec) | (μA/cm²) |
| Glassy carbon | 400 | 290 | 9.44 |
| 3 (MoS₂) | 250 | 187 | 107.8 |
| 7 (Mo_{0.77}W_{0.23}S₂) | 270 | 200 | 93.7 |
| 10 (Mo_{0.55}W_{0.45}S₂) | 280 | 206 | 63.9 |
| 15 (Mo_{0.77}W_{0.73}S₂) | 290 | 223 | 56.6 |
| 17 (WS₂) | 300 | 198 | 43.2 |
| Platinum | 40 | 31 | ∞ |

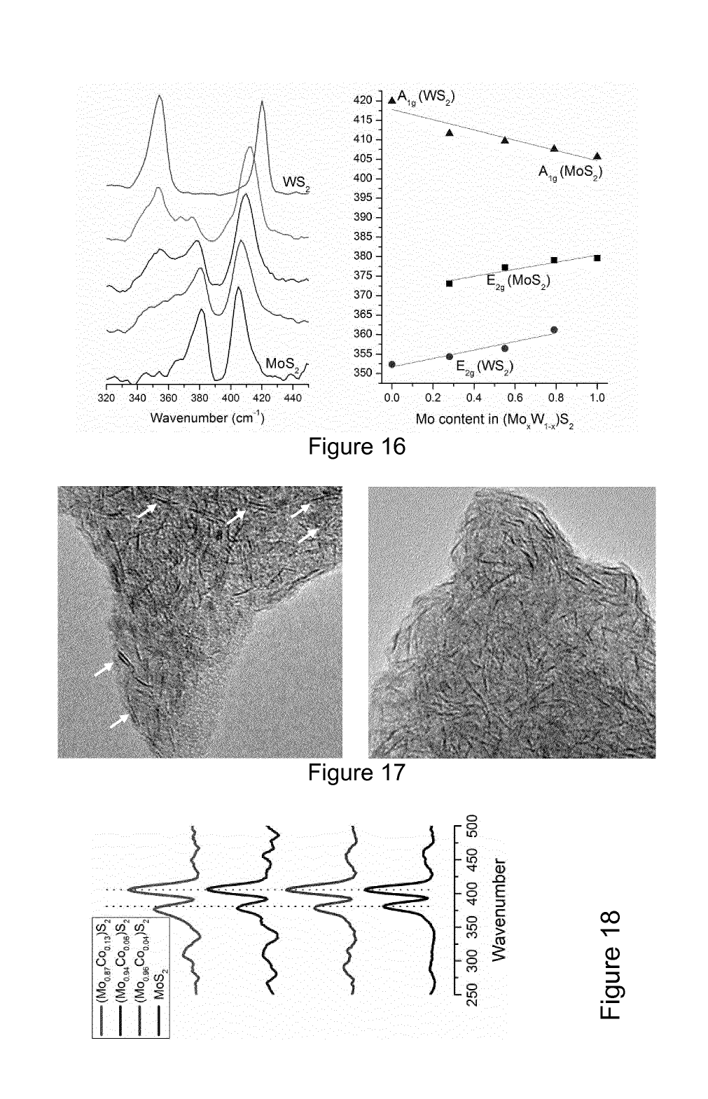

Before Raman spectroscopic analyses, restacked films of (MoₓW₁₋ₓ)S₂ were prepared by the annealing a small amount of MS₂@oleylamine in N₂ at 500° C., to remove the oleylamine ligand that often reduces the quality of the Raman spectrum. Raman spectroscopy of binary WS₂ (at all temperatures) possess two major bands at ca. 353 and 419 cm⁻¹, corresponding to the E_{2g} and A_{1g} bands. Similarly, the Raman spectra for the MoS₂ analogues gave two bands at ca. 381 and 405 cm⁻¹, which can be assigned to the E_{2g} and and A_{1g} optical modes, respectively. Raman spectroscopy was also used to investigate the ternary (MoₓW₁₋ₓ)S₂@oleylamine produced from mixtures of [Mo₂O₂S₂(S₂CNEt₂)₂]and [W₂S₄(S₂CNEt₂)₂].H₂O (FIG. 16). All of the ternary materials display a single band for the

A_{1g} phonon, alongside two phonon bands of E_{2g} symmetry. The dependence of the Raman shift for the three prominent bands in all films was plotted as a function of Mo content (mole fraction x), as found by ICP-OES (FIG. 16 right). The observation of these bands correlate well with the Raman modes observed for (MoₓW₁₋ₓ)S₂ thin films, produced by AACVD.

Metal or Metalloid Ion Doped Nanosheets The following representative example is directed to MoS₂ nanosheets doped with transition metal ions (derived from the chloride salt). It will be appreciated that these are provided by way of illustration and are not intended to limit the invention or disclosure herein.

(TM)-doped MoS₂@oleylamine samples were prepared by hot injection thermolysis, whereby a mixture of Mo₂O₂S₂(S₂CNEt₂)₂ and the selected MCl₂ dopant (total 0.75 mmol metal content) in oleylamine was injected into hot oleylamine. Reactions were carried out at the optimised temperature of 300° C. to produce dark-coloured suspensions which could be isolated as brittle solids. The reaction results in the formation of the target nanomaterials within a sulfur-rich environment—conditions which are thought to promote the substitutional doping of an Mo centre with a TM one. The inventors produced substitutional-doped MoS₂ nanosheets (based on the information provided herein).

ICP-OES confirmed that the Mo-to-(TM) ratios in all of the (TM)-doped MoS₂@oleylamine coincide with the initial precursor ratios used in the reaction. In addition, all of the samples were found to contain a metal-to-sulfur ratio of ˜1:2, supporting the MoS₂-nature of the nanosheets.

TEM analyses show that all of the ca. 12% (TM)-doped MoS₂@oleylamine samples consist of small MoS₂ nanosheets which form highly disordered, aggregated structures that are 100's to 1000's of nm in size. In addition, there was no evidence of any other forms of nanomaterials, suggesting there are no (TM)Sₓ-based nanomaterial impurities in the flocculates. High resolution TEM imaging shows that within these aggregates, the expected randomly oriented monolayer MoS₂ nanosheets are prevalent (FIG. 17). Statistical analysis of the doped-MoS₂ nanosheets within the samples (sample size in each study: N=40) found that in most cases, the nanosheets were monolayer and with lateral dimensions in the region of 5.5-6.0 nm—consistent with the results found in the assessment of undoped MoS₂@oleylamine. The exception to the above was for the 12% Cu-doped MoS₂@oleylamine, which found that the nanosheets were smaller (average lateral dimension of ca. 5.0 nm), but importantly found to contain significant amounts of bilayer and multilayer sheets. The interlayer separation in these sheets were found to be ca. 0.67 nm, consistent with the formation of an intercalatant-free multi-layered crystal.

12% Co-doped MoS₂@oleylamine was studied by high angle annular dark field (HAADF) scanning transmission electron microscope (STEM) imaging, and energy dispersive X-ray (EDX) spectrum imaging. Low magnification HAADF STEM images revealed aggregates of randomly oriented flakes, similar to those observed for un-doped MoS₂@oleylamine. Flakes lying with their basal planes parallel to the electron beam appear bight, such flakes are found to be monolayers with lateral dimensions of ˜8 nm or less. Higher magnification HAADF STEM images of flakes lying with their basal plane's perpendicular to the electron bean showed the expected hexagonal 1H-MoS₂crystal structure, the extent of organic contamination (deriving from oleylamine) limits the quality of atomic resolution images, this makes it challenging to distinguish Mo and Co atoms in such images. To confirm uniform Co alloying STEM EDX spectrum imaging was performed on the MoS₂@Oleylamine aggregates, the resulting elemental maps demonstrate nm scale co-localisation of Co, Mo, and S, with no evidence of Co rich or deficient regions seen. These facts support the conclusion that Co-introduction into the MoS₂ nanosheets produced a truly alloyed material, and not the formation of CoSₓ cluster or nanoparticles.

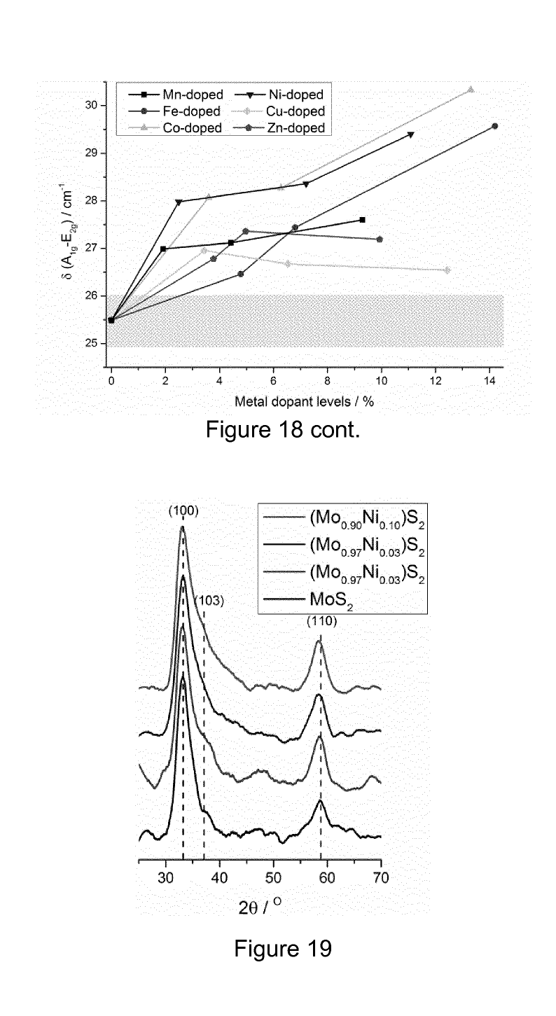

Before Raman spectroscopic analyses, restacked (TM)-doped-MoS₂ was prepared by the annealing a small amount of the (TM)-doped-MoS₂@oleylamine materials onto a Si substrate at 500° C. in a vacuum, to remove the oleylamine ligand that can often reduce the quality of the spectra obtained. Analyses of the (TM)-doped-MoS₂ display the same E_{2g} and A_{1g} bands as seen in binary MoS_{2.} However the band separation is dependent on both the metal dopant and dopant concentration; the largest separation was found to be over 30 cm⁻¹ with 12% Co-doping (FIG. 18). Reasoning for the increase in the band separations can be rationalised using the Co-doped MoS₂ as an example; the shift of the E_{2g} band thought to be as the composite E_{2g} vibrational modes of the 1H-MoS₂ and the structurally-confined 1 H-CoS₂ (381 and 374 cm⁻¹, respectively).

Grazing incidence-XRD of the TM-doped MoS₂@oleylamine thin films (prepared by the drop-casting of (TM)-doped MoS₂@oleylamine dispersions onto a glass substrate) display diffraction patterns that closely resemble each other: Highly broadened bands for the (100) (accompanied by a shoulder corresponding to the (103) plane) and (110) crystal planes of the layered TMDC in the 1H-phase are seen. Closer inspection all of the (TM)-doped MoS₂@oleylamine exhibits shifts in the (100) and (110) bands to lower 20 values, compared to the undoped MoS₂@oleylamine (FIG. 19). These small but non-negligible changes suggests that the MoS₂ crystal unit cell expands along the xy-plane. In general this unit cell expansion correlates with increasing dopant concentrations.

The magnetisation versus applied magnetic field curves of 12% TM-doped MoS₂@oleylamne at 2K were investigated. All curves show typical ferromagnetic behaviour. The saturation magnetisation of pure MoS₂@oleylamine was 0.056 emu/g: higher than previously reported values of freestanding MoS₂ sheets (0.0025 and 0.0011 emu/g at 10 and 300 K). This higher saturation magnetisation is possibly due to the relatively smaller lateral sheet dimensions that have been shown to increase the ferromagnetism of few-layer

MoS₂ sheets, or the generation of MoS₂ nanosheets with a higher concentration of exposed zig-zag edges. Upon doping with various transition metals, the saturation magnetisation increases linearly with dopant concentration in Mn, Fe, Co and Ni whilst Cu and Zn doping has a negligible effect. Mn-doping had the highest saturation magnetisation (2.8 emu.g⁻¹@ 10%-doping), followed by Fe (0.75 emu.g⁻¹@14%), Ni (0.63 emu.g⁻¹@14%), Co (0.44 emu.g⁻¹@14%), Cu (0.12 emu.g⁻¹@ 12%) and Zn (0.04 emu.g⁻¹@10%); reflecting the trend of unpaired electrons, and hence total magnetic moment, of 2+ transition metals. Doping concentration studies in (TM)-doped MoS₂ also found that the magnetisation of the materials linearly increased with increasing TM-content in the TM-doped MoS₂@oleylamine. This suggests that the degree of magnetisation in the produced nanosheets can be controlled by the simple control of dopant concentration.

### EXAMPLES

Methods: Elemental analyses were performed using a Thermo Scientific Flash 2000 Organic Elemental Analyser by the microanalytical laboratory at the University of Manchester.

Thermogravimetric analysis measurements were carried out by a Seiko SSC/S200 model under a heating rate of 10° C. min⁻ in both nitrogen and atmospheric conditions. Raman spectra were acquired on a Renshaw 1000 system, with a solid state (50 mW) 514.5 nm laser (operating at 10% power). The laser beam was focused onto the samples by a 50× objective lens. The scattered signal was detected by an air cooled CCD detector. Approximately 5 mg of the 1H-MoS₂@oleylamine dispersed in toluene was drop cast onto a glass substrate for p-XRD studies, performed on a Bruker AXS D8-Advance diffractometer, using Cu Kα radiation. The thin film samples were mounted flat and scanned over the range of 10-80° . FT-IR spectra were obtained by a Thermo Fisher Nicolet iS5 spectrometer equipped with an ATR cell. Samples for transmission electron microscopy (TEM) were prepared from dilute 1H-MoS₂@oleylamine dispersions in toluene (which were sonicated for 5 minutes) by drop casting onto holey carbon support films which were then washed with toluene and air dried. Bright field images and selected area electron diffraction (SAED) patterns were obtained using a Philips CM20 TEM equipped with a LaB6 electron source and operated at 200kV. STEM imaging and EDX analysis was performed in a probe-side aberration corrected FEI Titan G2 80-200 ChemiSTEM microscope operated at 200 kV equipped with the Super-X EDX detector with a total collection solid angle of 0.7 srad. For ADF imaging a probe current of ˜75 pA, convergence angle of 21 mrad and a detector inner angle of 28 mrad were used. EDX spectrum images were acquired with the sample at 0° tilt and with all four of the ChemiSTEM SDD detectors turned on. STEM images were recorded in FEI TIA software and EDX data was recorded and analysed using Bruker Esprit, quantification of EDX spectra was performed using the Cliff-Lorimer method (using the S K-series (2.31 keV) and Mo K-series (17.48 keV) and adsorption correction (assuming the flocculate has a density of bulk MoS₂ (5.06 cm⁻³) and thickness of 150 nm). Cyclic voltammetry (CV), electrochemical impedance spectroscopy (EIS), and galvanostatic charge/discharge (GCD) were performed using a PGSTAT302N potentiostat (Metrohm Autolab, The Netherlands). All electrochemical measurements were performed in a sealed symmetrical coin cell (CR2032) using an aqueous electrolyte (1M Na₂SO₄). The membranes were stacked back-to-back within the coin cell with the active material making direct contact with the current collector. EIS was performed at a frequency range of 0.1 Hz to 100 kHz with a 10 mV (RMS) perturbation and 0 V dc bias. Specific capacitance was calculated using the established best practice.^{[22]}

Synthesis of [Mo₂O₄(S₂CNEt₂)_{2]}

The synthesis of [Mo₂O₄(S₂CNEt₂)₂] was modified from that described in literature.^{[23]} In a nitrogen environment, MoCl₅ (5 g, 18 mmol) was carefully added to degassed H₂O (80 mL). The resulting solution was cooled to 5° C. before the removal of volatile gases (mainly HCl) by vacuum evacuation for 1 hour. After the reintroduction of nitrogen, the reaction was warmed to room temperature before a solution of NaS₂CNEt₂.3H₂O (4.1 g, 18.2 mmol) in degassed methanol (225 mL) was added slowly and heated to reflux for 30 minutes. The resulting yellow precipitate was filtered, washed with a H₂O/EtOH solution (1:3, 2×75 mL) and dried in a vacuum overnight to give pure [Mo₂O₄(S₂CNEt₂)₂] as a yellow powder (6.75 g, 12.2 mmol, 68%). Anal. calcd for C₁₀H₂₀Mo₂N₂O₄S_{4:} C 21.74, H 3.65, N 5.07, S 23.17; found: C 21.97, H 3.51, N 5.05, S 23.30.

Synthesis of [Mo₂O₂Sₛ(S₂CNEt₂)₂₁]

The synthesis of [Mo₂O₂Sₛ(S₂CNEt₂)₂] follows the procedure described in literature.^{[23]} Yield —1.01 g (1.73 mmol, 80%) Anal. calcd for C₁₀H₂₀Mo₂N₂O₂S₆: C 20.57, H 3.45, N 3.45, S 32.85; found: C 20.69, H 3.48, N 4.74, S 32.85.

Synthesis of [Mo₂S₄(S₂CNEt₂)_{2]}

Complex [Mo₂S₄(S₂CNEt₂)₂] was synthesised by two separate routes:

The first method was modified from that described in the literature.^{[24]} In a dry nitrogen environment, [Mo2O4(S2CNEt2)2] (3 g, 5.44 mmol) and P4S10 (1.2 g, 2.72 mmol) were added to p-xylene (150 mL), before heating to reflux for 3 hours. The solution was then hot-filtered and the filtrate cooled to room temperature, yielding an orange-red microcrystalline powder. The powder was filtered and washed with cold toluene (2×30 mL) and dried in a vacuum overnight to give [Mo₂S₄(S₂CNEt₂)₂] as an orange-red powder (1.31 g, 2.12 mmol, 39%). Anal. calcd for C₁₀H₂₀Mo₂N₂S_{8:} C 19.50, H 3.27, N 4.55, S 41.53; found: C 19.33, H 3.11, N 4.61, s 41.09.

The second method follows the procedure described in literature.^{[25]} Yield—2.9 g (4.7 mmol, 61%). Anal. calcd for C10H20Mo₂N₂Ss: C 19.50, H 3.27, N 4.55, S 41.53; found: C 19.61, H 3.31, N 4.53, S 41.98.

Synthesis of [Mo₂O₂S₂(S₂COEt)₂]

The procedure used was modified from that described in literature.^{[26]} In a dry nitrogen environment, a slow stream of H₂S was bubbled through a solution of [Mo₂O₃(S₂COEt)₄] (5.6 g, 7.7 mmol) in dry chloroform (250 mL) for two hours. The reaction was sealed in the H₂S-rich environment and stirred overnight. After careful removal of volatile gases, the solvent was evaporated by vacuum to leave a dark brown powder. The by-products were removed from the solids by acetone extraction (2×100 mL) and filtration to give an orange powder. The powder was washed with acetone (2×50 mL) and dried in a vacuum to give pure [Mo₂O₂S₂(S₂COEt)₂] as an orange powder (3.0 g, 5.6 mmol, 73%). Anal. Calcd. for C₆H₁₀MoO₄S_{6:} C 13.68, H 2.33, S 36.00; found: C 13.59, H 1.90, S 36.00.

Synthesis of [Mo₂S₄(S₂COEt)₂]

The synthesis of [Mo₂S₄(S₂COEt)₂] was modified from that described in literature.^{[27]} In a dry nitrogen environment, a slow stream of H₂S was bubbled through a solution of [Mo₂O₃(S₂COEt)₄] (10 g, 13.8 mmol) in a toluene-ethanol solvent mixture (4:1, 250 mL) for two hours. The reaction was sealed in the H₂S-rich environment and stirred overnight. The dark-brown precipitate was filtered, washed with petroleum ether (3×100 mL) and dried in a vacuum to give pure [Mo₂S₄(S₂COEt)₂] as a dark brown solid (3.9 g, 7.0 mmol, 51%). Anal. calcd for C₆H₁₀MoO₂S₈: C 12.82, H 1.79, S 45.53; found: C 12.58, H 1.71, S 45.04.

1H-MoS₂@Oleylamine Synthesis by Hot Injection-Thermolysis

In a typical synthesis, a 200 mg solution of [Mo₂O₂S₂(S₂COEt)₂] in oleylamine (5 mL) was rapidly added to hot oleylamine (25 mL; reaction temperatures from 200 to 325° C.) under stirring. The solution turned a black colour and drops in reaction temperatures of 10-38° C. was observed; the reaction was kept at the lower temperature after addition. 9 mL aliquots were taken at regular intervals and added to methanol (35 mL), resulting in a flocculant-like precipitate. The black precipitate was separated by centrifugation (4,000 rpm for 20 minutes) and the supernatant removed. The precipitate was washed by repeated dispersion into 30 mL methanol and centrifugation before 1H-MoS₂@oleylamine was finally dried in a vacuum for 16 hours.

Synthesis of [W₂S₄(S₂CNEt₂)₂].Monohydrate

An aqueous solution (300 mL) of [NH₄]₂[WS₄] (2.91 g, 8.36 mmol) and Na(S₂CNEt₂).3H₂O (7.6 g, 33.77 mmol) was vigorously stirred whilst a 2M HCl solution was added dropwise until a pH2 solution was obtained. The addition initially produced a yellow precipitate, which eventually turned dark green with continual HCl addition. The resulting suspension was stirred for a further 30 minutes, before filtration, and the dark coloured precipitate was washed with water (3×100 mL) and dried in a high-vacuum for an hour. The crude product was dissolved in acetone (250 mL), filtered and the precipitates washed with acetone (3×40 mL) to give a dark green solution and an orange-brown powder. The orange-brown powder was dried in a high vacuum to give pure W₂S₄(S₂CNEt₂)₂ (0.99 g, 1.25 mmol, 20.9%). In addition, the green solution can be stripped of its solvent by evaporation before drying in a high vacuum to give pure WS(S₂)(S₂CNEt₂)₂ as a dark green powder (2.53 g, 4.39 mmol, 52.5%). Elemental analysis and other analytical data confirm purity, and cold storage (−30° C.) prevented decomposition.

Thermogravimetric analysis (TGA) of [W₂S₄(S₂CNEt₂)₂].H₂O showed that the hydrate ligand fully desorbs at 270° C. (trace not shown). The complex itself decomposes in three steps, from 316 to 421 ° C., with the final weight of the residues of 65.3% (at 600° C.), in close agreement to the predicted residual weights of two WS₂ molecules (61.2%). The decomposition profile of [W₂S₄(S₂CNEt₂)₂].H₂O is significantly cleaner than that of molybdenum analogue [Mo₂S₄(S₂CNEt₂)₂]. [Mo₂O₂S₂(S₂CNEt₂)₂] was selected as the molybdenum source for this experiment, as its decomposition profile was the best match. Naturally, other precursors (such as those described herein) may be used.

1H-(MoₓW₁₋ₓ), S₂@Oleylamine Synthesis by Hot Injection-Thermolysis

In a typical synthesis, a 0.25 mmol of the total precursors (i.e. a mixture of x mmol [Mo₂O₂S₂(S₂CNEt₂)₂] and [W₂S₄(S₂CNEt₂)₂].(H₂O) in oleylamine (5 mL) was rapidly added to hot oleylamine (25 mL; reaction temperatures from 250 to 325° C.) under stirring. The solution turned a black colour and a drops in reaction temperature of 16-35° C. was typically observed; the reaction was kept at the lower temperature after addition. After 10 minutes the contents of the reactor was poured into 50 mL isopropanol and allowed to cool to room temperature, resulting in a flocculant-like precipitate. The resulting suspensions were diluted by half with methanol and the precipitates were separated by centrifugation (4,000 rpm for 20 minutes) and the supernatant removed. The precipitate was washed by twice dispersing into methanol (30 mL) and centrifugation and separation, followed by dispersion into acetone (30 mL) and a further centrifugation and separation step. The 1H-MoS₂@oleylamine was finally dried in a vacuum for 16 hours.

The analogous synthesis of WS₂ and ReS₂ nanosheets is described earlier in the application.

Transition Metal Ion Doped Nanosheets

In a typical synthesis, an oleylamine solution (5 mL) containing a mixture of the metal complex (in this example, Mo₂O₂S₂(S₂CNEt₂)₂) and (TM)Cl₂ (TM=Mn, Fe, Co, Ni, Cu or Zn; in a 0.97:0.03, 0.94:0.06 or 0.88:0.12 molar ratio; total 0.75 mmol w.r.t metal atoms) was rapidly added to hot oleylamine (25 mL, 300° C.) under stirring. The solution turned a black colour and a drop in reaction temperatures of ca. 25° C. was observed; the reaction was kept at the lower temperature after addition. After 8 minutes the contents of the reactor was poured into 50 mL isopropanol and allowed to cool to room temperature, resulting in a flocculant-like precipitate. The resulting suspensions were diluted by half with methanol and the precipitates were separated by centrifugation (9,000 rpm for 20 minutes) and the supernatant removed. The precipitate was washed by twice dispersing into methanol (30 mL), centrifugation and separation, followed by dispersion into acetone (30 mL) and a further centrifugation and separation step. The (TM)-doped-MoS₂@oleylamine was finally dried in a vacuum for 16 hours.

Electrochemistry

Graphene dispersions were produced by solution ultrasonication using previously reported methods.^{[28]} Briefly, graphite flakes were dispersed in N-methyl-2-pyrrolidone (10 mg/ml) and bath sonicated for 12 hours before centrifugation to remove any poorly exfoliated material. MoS₂ dispersions were produced by first removing the oleylamine by thermal annealing (500° C., in N₂), the resulting material was redispersed in NMP and combined with the graphene dispersion in a 1:1 ratio by weight. The concentration for the MoS₂-NMP and graphene-NMP dispersions were determined by UV-Vis. Films of the MoS2 and graphene composite were synthesized by first diluting the NMP dispersions in isopropanol (IPA) by a factor of 20 followed by filtering through PVDF filters with 0.1 μm pore size. The mass of active materials used on each membrane was ˜1 mg (1 mg/cm²).

It is to be understood that the examples and embodiments described herein are for illustrative purposes and that various modifications or changes in light thereof will be suggested to a person skilled in the art and are included in the spirit and scope of the invention and the appended claims.

The following references are cited in this application and are incorporated by reference for all purposes:

[1] C. De Mello Donega, P. Liljeroth, D. Vanmaekelbergh, Small 2005, 1, 1152.

[2] R. Huirache-Acuña, F. Paraguay-Delgado, M. A. Albiter, J. Lara-Romero, R. Martínez-Sánchez, Mater. Charact. 2009, 60, 932.

[3] C. Altavilla, M. Sarno, P. Ciambelli, Chem. Mater. 2011, 23, 3879.

[4] (a) L. Cheng, W. Huang, Q. Gong, C. Liu, Z. Liu, Y. Li, H. Dai, Angewandte Chemie 2014, 53, 7860. [14] E. Leite, C. Ribeiro, Crystallization and Growth of Colloidal Nanocrystals, Springer New York, 2012; (b) L. Cheng, C. Yuan, S. Shen, X. Yi, H. Gong, K. Yang and Z. Li, ACS Nano, 2015, 9, 11090.

[5] E. Leite, C. Ribeiro, Crystallization and Growth of Colloidal Nanocrystals, Springer New York, 2012.

[6] F. Withers, H. Yang, L. Britnell, A. P. Rooney, E. Lewis, A. Felten, C. R. Woods, V. Sanchez Romaguera, T. Georgiou, A. Eckmann, Y. J. Kim, S. G. Yeates, S. J. Haigh, A. K. Geim, K. S. Novoselov, C. Casiraghi, Nano letters 2014, 14, 3987; Y. Huafeng, W. Freddie, G. Elias, L. Edward, B. Liam, F. Alexandre, P. Vincenzo, H. Sarah, B. David, C. Cinzia, 2D Mater. 2014, 1, 011012.

[7] H. S. Matte, A. Gomathi, A. K. Manna, D. J. Late, R. Datta, S. K. Pati, C. N. Rao, Angewandte Chemie 2010, 49, 4059; K. H. Hu, X. G. Hu, Y. F. Xu, X. Z. Pan, React Kinet Mech Cat 2010, 100, 153.

[8] N. Savjani, J. R. Brent, P. O'brien, Chem. Vap. Depos. 2015, 21, 71.

[9] S. L. Li, H. Miyazaki, H. Song, H. Kuramochi, S. Nakaharai, K. Tsukagoshi, ACS nano 2012, 6, 7381.

[10] G. L. Frey, R. Tenne, M. J. Matthews, M. S. Dresselhaus, G. Dresselhaus, Phys. Rev. B 1999, 60, 2883.

[11] M. D. Stoller, R. S. Ruoff, Energ Environ Sci 2010, 3, 1294.

[12] Y. Hernandez, V. Nicolosi, M. Lotya, F. M. Blighe, Z. Sun, S. De, I. T. Mcgovern, B. Holland, M. Byrne, Y. K. Gun'ko, J. J. Boland, P. Niraj, G. Duesberg, S. Krishnamurthy, R. Goodhue, J. Hutchison, V. Scardaci, A. C. Ferrari, J. N. Coleman, Nat. Nanotechnol. 2008, 3, 563.

[13] Z. N. Yu, L. Tetard, L. Zhai, J. Thomas, Energ Environ Sci 2015, 8, 702.

[14] M. A. Bissett, I. A. Kinloch, R. A. W. Dryfe, Adv. Energ. Mater. 2015.

[15] M. A. Bissett, I. A. Kinloch, R. A. W. Dryfe, ACS applied materials & interfaces 2015.

[16] J. M. Soon, K. P. Loh, Electrochem Solid St 2007, 10, A250; S. Patil, A. Harle, S. Sathaye, K. Patil, Crystengcomm 2014, 16, 10845, X. Cao, Y. Shi, W. Shi, X. Rui, Q. Yan, J. Kong, H. Zhang, Small 2013, 9, 3433.

[17] L. Cao, S. Yang, W. Gao, Z. Liu, Y. Gong, L. Ma, G. Shi, S. Lei, Y. Zhang, S. Zhang, R. Vajtai, P. M. Ajayan, Small 2013, 9, 2905; K. J. Huang, L. Wang, Y. J. Liu, Y. M. Liu, H. B. Wang, T. Gan, L. L. Wang, Int J Hydrogen Energ 2013, 38, 14027; E. G. Da Silveira Firmiano, A. C. Rabelo, C. J. Dalmaschio, A. N. Pinheiro, E. C. Pereira, W. H. Schreiner, E. R. Leite, Adv. Energ. Mater. 2014, 4, n/a.

[18] A. Winchester, S. Ghosh, S. Feng, A. L. Elias, T. Mallouk, M. Terrones, S. Talapatra, ACS applied materials & interfaces 2014, 6, 2125.

[19] J. N. Coleman, M. Lotya, A. O'neill, S. D. Bergin, P. J. King, U. Khan, K. Young, A. Gaucher, S. De, R. J. Smith, I. V. Shvets, S. K. Arora, G. Stanton, H.-Y. Kim, K. Lee, G. T. Kim, G. S. Duesberg, T. Hallam, J. J. Boland, J. J. Wang, J. F. Donegan, J. C. Grunlan, G. Moriarty, A. Shmeliov, R. J. Nicholls, J. M. Perkins, E. M. Grieveson, K. Theuwissen, D. W. Mccomb, P. D. Nellist, V. Nicolosi, Science 2011, 331, 568.

[20] T. F. Jaramillo, K. P. Jorgensen, J. Bonde, J. H. Nielsen, S. Horch, I. Chorkendorff, Science 2007, 317, 100.

[21] Taberna, P. L.; Simon, P.; Fauvarque , J. F. Electrochemical Characteristics and Impedance Spectroscopy Studies of Carbon-Carbon Supercapacitors. J. Electrochem. Soc. 2003, 150 (3), A292-A300.

[22] M. D. Stoller, R. S. Ruoff, Energ Environ Sci 2010, 3, 1294.

[23] A. Schultz, V. R. Ott, D. S. Rolison, D. C. Bravard, J. W. McDonald, W. E. Newton, Inorg. Chem. 1978, 17, 1758-1765.

[24] M. A. Malik, P. O'Brien, A. Adeogun, M. Helliwell, J. Raftery, J. Coord Chem. 2008, 61, 79-84.

[25] H. Coy Diaz, R. Addou, M. Batzill, Nanoscale 2014, 6, 1071-1078.

[26] W. E. Newton, J. L. Corbin, D. C. Bravard, J. E. Searles, J. W. Mcdonald, Inorg. Chem. 1974, 13, 1100.

[27] C. Gong, C. Huang, J. Miller, L. Cheng, Y. Hao, D. Cobden, J. Kim, R. S. Ruoff, R. M. Wallace, K. Cho, X. Xu, Y. J. Chabal, ACS Nano 2013, 7, 11350-11357.

[28] Y. Hernandez, V. Nicolosi, M. Lotya, F. M. Blighe, Z. Sun, S. De, I. T. Mcgovern, B. Holland, M. Byrne, Y. K. Gun'ko, J. J. Boland, P. Niraj, G. Duesberg, S. Krishnamurthy, R. Goodhue, J. Hutchison, V. Scardaci, A. C. Ferrari, J. N. Coleman, Nature nanotechnology 2008, 3, 563.

1. A method for the synthesis of 2D metal chalcogenide nanosheets, the method comprising adding a metal complex to a dispersing medium which is at elevated temperature, wherein the metal complex comprises a metal ion and a ligand comprising at least two atoms selected from oxygen, sulfur, selenium, and tellurium, to form a dispersion of the 2D metal chalcogenide nanosheets in the dispersing medium.

2. A method for the synthesis of metal-ion or metalloid-ion doped 2D metal chalcogenide nanosheets, the method comprising adding a metal complex to a dispersing medium which is at elevated temperature, wherein the reaction is performed in the presence of a salt of said metal or metalloid ion, and wherein the complex comprises a metal ion and a ligand comprising at least two atoms selected from oxygen, sulfur, selenium and tellurium, to form a dispersion of the 2D metal chalcogenide nanosheets in the dispersing medium.

3. The method of claim 1, wherein the ligand comprises at least two atoms selected from sulfur and selenium.

4. The method of claim 1, wherein the metal complex comprises a transition metal ion, optionally wherein the metal complex comprises a molybdenum or tungsten ion.

5. The method of claim 1, wherein the method is a method for the synthesis of metal-ion doped 2D metal chalcogenide nanosheets, optionally wherein the metal ion is selected from manganese, iron, cobalt, nickel, copper, and zinc.

6. The method of claim 1, wherein the salt of said metal or metalloid ion is a halide, optionally wherein the salt is a chloride.

7. The method of claim 1, wherein the ligand is a chalcogenocarbamate or chalcogenocarbonate ion, optionally wherein the ligand is a dithiol-carbamate or a dithiol-carbonate or a diseleno-carbamate or diseleno-carbonate.

8. The method of claim 1, wherein the complex is a complex of formula (IV): 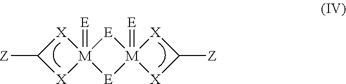
wherein
each E is O, S, or Se,
each X is S or Se,
each Z is OR¹ or NR²R³;
R¹, R², and R³ are independently selected from optionally substituted alkyl, alkyenyl, cycloalkyl, cyclocalkyl-C₁₋₆alkyl, cycloalkenyl, cycloalkenyl-C₁₋₆alkyl, heterocyclyl, heterocyclyl-C₁₋₆alkyl, aryl, aryl-C₁₋₆alkyl, and heteroaryl-C₁₋₆alkyl.

9. The method of claim 1, wherein the dispersing medium comprises at least one coordinating group selected from an amino group, a hydroxyl group, a carboxylic acid group, a phosphonic acid group, a phosphine group, and a phosphine oxide group.

10. The method of claim 1, wherein the 2D material is a binary 2D material.

11. The method of claim 1, wherein the nanosheets have a mean lateral dimension of from 4 to 10 nm with a size distribution no more than ±20% of the mean lateral dimension, preferably no more than ±15%.

12. The method of claim 1, the method further comprising a step of thermally annealing the nanosheets at a temperature of 350° C. or higher.

13. A composition comprising 2D metal chalcogenide nanosheets, wherein the variation in lateral dimension of the nanosheets is less than ±20%, preferably less than ±15%.

14. The composition of claim 13, wherein the 2D metal chalcogenide is MoS₂.

15. The composition of claim 13, wherein the nanosheets have a mean lateral dimension of about 5 nm or wherein the nanosheets have a mean lateral dimension of about 7 nm or wherein the nanosheets have a mean lateral dimension of about 9 nm or wherein the nanosheets have a mean lateral dimension of about 11 nm.

16. A capacitor comprising nanosheets according to claim 13, wherein the nanosheets are provided as a composite with graphene.
